(19) United States
(12) Patent Application Publication
(10) Pub. No.: US 2004/0027368 A1
(43) Pub. Date: Feb. 12, 2004

(54) Time sheet for real time video production system and method

(75) Inventors: Robert J. Snyder, St. Augustine, FL (US); Richard Todd, Jacksonville, FL (US); John R. Benson, Jacksonville, FL (US); Alex Holtz, Jacksonville, FL (US); William H. Couch, Fernandina Beach, FL (US); Marcel LaRocque, Jacksonville, FL (US); Kevin K. Morrow, Jacksonville, FL (US); Charles M. Hoeppner, Jacksonville, FL (US); Keith G. Tingle, Neptune Beach, FL (US)

Correspondence Address: STERNE, KESSLER, GOLDSTEIN & FOX PLLC, 1100 NEW YORK AVENUE, N.W., WASHINGTON, DC, 20005, US

(73) Assignee: ParkerVision, Inc.

(21) Appl. No.: 10/431,576

(22) Filed: May 8, 2003

Related U.S. Application Data
(60) Provisional application No. 60/378,655, filed on May 9, 2002.

(51) Int. Cl. G09G 5/00

(52) U.S. Cl. 345/716

(57) ABSTRACT

An integrated, fully automated video production system that provides a video director with total control over all of the video production devices used in producing a show via a hierarchical time sheet. The video production system provides an automation capability that allows the video director to pre-produce a show, review the show in advance of “air time,” and then, with a touch of a button, produce the live show. In one embodiment, the invention provides a video production system having a processing unit in communication with one or more of the video production devices mentioned above. According to an embodiment, the video director pre-produces the show, defines a set of video production commands or instructions (hereafter “transition macro”) to be executed by the processing unit, and then, by activating a control button displayed by the processing unit, the video director instructs the processing unit to execute the transition macro via the hierarchical time sheet. The hierarchical time sheet includes a plurality of control lines and a possible plurality of hierarchical group layers. Each of the control lines corresponds to a video production device in a preferred embodiment. The video director creates a transition macro by defining one or more hierarchical group layer GUIs, where the group layer GUIs may include an object group layer GUI, a TME group layer GUI, a page group layer GUI, a story layer GUI and a show layer GUI. A show is the container for everything, which can be divided into various story layers. A story can contain multiple page layers, a page layer can contain multiple TME layers, and a TME layers can contain multiple object layers.

### CROSS-REFERENCE TO RELATED APPLICATIONS

The present application claims priority to U.S. provisional patent application entitled “Enhanced Timeline,” Ser. No. 60/378,655 (Attorney Docket No. 1752.0490000), by Holtz et al., filed May 9, 2002, incorporated herein by reference.

The following United States utility patent applications have a common assignee and contain some common disclosure:

“Real Time Video Production System and Method,” Ser. No. 09/215,161 (Attorney Docket No. 1752.0010000), by Holtz et al., filed Dec. 18, 1998, now U.S. Pat. No. 6,452,612, incorporated herein by reference;

“System and Method for Real Time Video Production and Multicasting,” Ser. No. 09/634,735 (Attorney Docket No. 1752.0010003), by Snyder et al., filed Aug. 8, 2000, incorporated herein by reference;

“Method, System and Computer Program Product for Full News Integration and Automation in a Real Time Video Production Environment,” Ser. No. 09/822,855 (Attorney Docket No. 1752.0130001), by Holtz et al., filed Apr. 2, 2001, incorporated herein by reference;

“Method, System and Computer Program Product for Producing and Distributing Enhanced Media Downstreams,” Ser. No. 09/836,239 (Attorney Docket No. 1752.0200000), filed Apr. 18, 2001, by Holtz et al., incorporated herein by reference; and

“Real Time Video Production System and Method,” Ser. No. 10/200,776, by Holtz et al. (Attorney Docket No. 1752.0010005), filed Jul. 24, 2002, incorporated herein by reference.

### BACKGROUND OF THE INVENTION

1. Field of the Invention

The present invention relates generally to video production, and more specifically, to a system, method and computer program product for automating the execution of a live or live-to-tape video show.

2. Related Art

Conventionally, the execution of a live or live-to-tape video show, such as a network news broadcast, talk show, or the like, is largely a manual process involving a team of specialized individuals working together in a video production environment having a studio and a control room. The video production environment is comprised of many diverse types of video production devices, such as video cameras, microphones, video tape recorders (VTRs), video switching devices, audio mixers, digital video effects devices, teleprompters, and video graphic overlay devices, etc. The basics of video production techniques is described in “Television Production Handbook,” Zettl, 1997 Wadsworth Publishing Company, which is incorporated herein by reference.

In a conventional production environment, the video production devices are manually operated by a production crew (which does not include the performers and actors, also known as the “talent”) of artistic and technical personnel working together under the direction of a director. A standard production crew is made up of nine or more individuals, including camera operators (usually one for each camera, where there are usually three cameras), a video engineer who controls the camera control units (CCUs) for each camera, a teleprompter operator, a character generator operator, a lighting director who controls the studio lights, a technical director who controls the video switcher, an audio technician who controls an audio mixer, tape operator(s) who control(s) a bank of VTRs, and a floor director inside the studio who gives cues to the talent. Typically, the director coordinates the entire production crew by issuing verbal instructions to them according to a script referred to as a director's rundown sheet. Generally, each member of the production crew is equipped with a headset and a microphone to allow constant communication with each other and the director through an intercom system.

During the execution of a live or live-to-tape video show, the production crew must perform multiple parallel tasks using the variety of video production devices. Furthermore, these tasks must all be coordinated and precisely synchronized according to very strict timing requirements. Coordination between the production crew, the director and the talent is vitally important for the successful execution of a show. Accordingly, the logistics of executing a show are extremely difficult to plan and realize.

Executing a show is extremely susceptible to errors. The industry knows that errors are generally expected to occur during the execution of a show. Accordingly, experienced production crews not only attempt to reduce the frequency of errors, but also attempt to react quickly in taking corrective action so that the inevitable errors that do occur are unnoticed by the viewing audience. However, it is quite apparent by watching live television broadcasts that this goal is not always met.

Another problem with the conventional production environment is that the director does not have total control in executing a show because of the director's reliance on the production crew. The production crew does not always follow the instructions of the director due to mis-communication and/or misinterpretation of the director's cues. Further, the director cannot achieve certain desired transitions and sophisticated or enhanced visual effects because of the real time nature of the execution of the show and the fast paced/short time available.

The real time nature of the execution of the show creates great stress for the director, the production crew, and the talent. Everyone is extremely concerned about failure. The real time nature of the execution of the show also necessitates re-creation of the format, including transitions and special effects, for the show.

Another drawback of the conventional production environment, is that failure of any member of the production crew to be present for the execution of the show may prevent or hamper the show from occurring as planned. Thus, directors constantly worry about whether crew members will show up for work, particularly on weekends and holidays.

Conversely, there are situations in other than broadcast environments, such as business television and video training environments, where due to downsizing or budgetary constraints the number of available personnel for the production crew is so limited that shows cannot be produced with high quality.

Producing live or live-to-tape video shows is very expensive because of the large size of the video production crew. The compensation to the individuals that make up the production crew is substantial, and can run in the range of several Million dollars per year for the entire crew. Furthermore, the compensation for a member of a production crew is commensurate with the video market of the station. The level of compensation for the top markets is substantially higher than for the lesser markets, and the compensation for network affiliates is higher than independent broadcasters and cable networks. This disparity in compensation produces frequent turnover in production crew personnel causing a director to frequently hire and train new members of the crew.

Another disadvantage with the conventional production environment is the inability to preview the show. That is, it is costly and impractical for the production crew to rehearse the show prior to its execution. The talent and the director cannot preview the transitions in a succinct manner.

Therefore, what is needed is a video production system and method that addresses the above problems.

Definitions of Terms

Certain terms used in this document have specific meanings as follows:

“Activating an icon” means selecting or triggering the icon.

“Button” is an icon that is intended to represent an electrical push-button appearing as part of a graphical user interface. Moving a mouse pointer over the graphical button and pressing one of the physical mouse buttons starts some software action.

“Execution of a show” means the implementation of the steps necessary to broadcast the show or record it in any tangible medium of expression.

“Frame” a frame is one-thirtieth of a second.

“Graphical Controls” are one or more icons used for controlling a video production device.

“Hot-key” is a programmable icon.

“Icon” means a small picture intended to represent something in a graphical user interface. When an icon is clicked on with a mouse, for example, some action is performed. Icons are usually stored as bitmaps, but of course can be stored using other formats.

“Pre-production” is the planning process whereby the video director plans the steps necessary to execute the show.

“Show” is a live or live-to-tape production.

“Show template” is a stored file of a transition macro that can be used in whole or in part as a starting point to produce another show.

“Transition macro” means a set of video production commands, where each video production command is transmitted from a processing unit to a video production device. Transition macro also refers to a set of icons that have been dragged and dropped (i.e., assembled) onto the control lines of a transition macro time sheet.

“Video production command” is any command or instruction that controls a video production device.

### SUMMARY OF THE INVENTION

The present invention solves the above identified problems in conventional systems by providing an integrated video production system, method and computer program product (referred to collectively as “video production system” for purposes of brevity) for automating the execution of a live or live-to-tape video show. The video production system is integrated such that a single person (“a video director”) has control over all video production devices used in executing the show. Such devices include, but are not limited to, video cameras, robotic pan/tilt heads, video tape players and recorders (VTRs), video servers and virtual recorders, character generators, still stores, digital video disk players (DVDs), digital video effects (DVE), audio mixers, audio sources (e.g., CD's and DAT's), video switchers, and teleprompting systems.

The automation capability provided by the video production system allows the video director to pre-produce a live show (such as a news show or talk show), preview the show in advance of “air time”, and then, with a touch of a button or other trigger, execute the live show. Consequently, a live show or live-to-tape show can be executed more cost efficiently, with greater control over logistics and personnel, with enhanced functionality and transitions, in less time and with less stress, and with fewer people and fewer human errors than was previously possible. The present invention also allows the video director to reuse formats of prior shows by leveraging show templates.

In an embodiment, a video production system is provided having a processing unit in communication with and/or controlling one or more of the video production devices mentioned above. The processing unit displays on a monitor or other display device a graphical user interface (GUI) that consists of graphical controls for controlling the video production devices that it is in communication with. The graphical controls are made up of icons that the video director activates to control a video production device. The video director uses a keyboard and mouse or other input device or interface (including voice activated, touch screen, heads up display, etc.) to activate the icons, and thereby remotely control the video production devices. In this manner, a director is given control over video production devices used in executing a show.

The processing unit also enables the video director to automate the execution of a show. According to an embodiment, the video director pre-produces the show to create a director's rundown-sheet, creates a transition macro (or multiple transition macros), which specifies one or more video production commands, and instructs the processing unit to execute the transition macro. Executing a transition macro means transmitting the one or more video production commands that are specified by the transition macro to the appropriate video production devices.

Upon receiving a video production command, a video production device performs the function corresponding to the received command. In this manner, the processing unit provides automated control of the video production devices, and thereby provides a system for automating the execution of a show in real time. This feature provides the director with the advantage of not having to rely on a production crew to execute a show. The cost and time savings this feature provides are therefore substantial. Additionally, the human errors that normally occur during the execution of a show are no longer an issue.

Advantageously, the invention may include a timer and means for associating a timer value with each video production command specified by the transition macro, thereby creating a timer driven transition macro. In this embodiment, a video production command is transmitted to a video production device only when the timer reaches the timer value associated with the video production command. An advantage of this feature is that the video production commands are scheduled according to the timer. The timer is activated by the video director activating a timer start icon displayed by the processing unit or is activated by the processing unit receiving a timer start command from an external system, such as a teleprompting system. The timer can also be stopped at any point in time, thereby providing the video director with control over the execution of a transition macro.

In an embodiment, the processing unit is programmed to provide a graphical user interface (GUI) that enables the director to easily create timer driven transition macros via a hierarchical time sheet. The hierarchical time sheet includes a plurality of control lines and a possible plurality of hierarchical group layers. Each of the control lines corresponds to a video production device in a preferred embodiment. The video director creates a transition macro by defining one or more hierarchical group layer GUIs, where the group layer GUIs may include an object group layer GUI, a TME group layer GUI, a page group layer GUI, a story layer GUI and a show layer GUI. A show is the container for everything, which can be divided into various story layers. A story can contain multiple page layers, a page layer can contain multiple TME layers, and a TME layers can contain multiple object layers.

Further features and advantages of the present invention, as well as the structure and operation of various embodiments of the present invention, are described in detail below with reference to the accompanying drawings.

### BRIEF DESCRIPTION OF THE FIGURES

The accompanying drawings, which are incorporated herein and form part of the specification, illustrate the present invention and, together with the description, further serve to explain the principles of the invention and to enable a person skilled in the pertinent art to make and use the invention. In the drawings, like reference numbers indicate identical or functionally similar elements. Additionally, the left-most digit(s) of a reference number identifies the drawing in which the reference number first appears.

FIG. 1 illustrates an embodiment of an integrated, fully automated video production system.

FIG. 2 illustrates an interactive graphical user interface (GUI) for the fully automated video production system according to an embodiment of the present invention.

FIG. 3 illustrates a block diagram of an example computer system useful for implementing the present invention.

FIG. 4 illustrates an interactive graphical user interface (GUI) for the fully automated video production system according to an embodiment of the present invention.

FIG. 5 illustrates an alternative view of the time sheet GUI of FIG. 4.

FIG. 6 illustrates of an encode mark configuration GUI according to an embodiment of the present invention.

FIG. 7 illustrates an alternative view of the time sheet GUI of FIG. 4.

FIG. 8 illustrates an encode object configuration GUI according to an embodiment of the present invention.

FIG. 9 illustrates the hierarchy of the group levels according to an embodiment of the present invention.

FIG. 10 further illustrates the group level hierarchy of FIG. 9.

FIG. 11 illustrates the object group layer GUI according to an embodiment of the present invention.

FIG. 12 illustrates the TME group layer GUI according to an embodiment of the present invention.

FIG. 13 illustrates the page group layer GUI according to an embodiment of the present invention.

FIG. 14 illustrates the story group layer GUI according to an embodiment of the present invention.

FIG. 15 illustrates an example time sheet row setup dialog according to an embodiment of the present invention.

FIG. 16 illustrates an example operation flowchart of the present invention upon receiving a command from the user to exit time sheet row setup dialog in FIG. 15 according to an embodiment of the present invention.

FIG. 17 illustrates an example time sheet layout setup dialog according to an embodiment of the present invention.

FIG. 18 illustrates an example timeline prep setup dialog according to an embodiment of the present invention.

FIG. 19 illustrates another embodiment of the page group layer GUI of the present invention.

FIG. 20 illustrates example GUI buttons according to an embodiment of the present invention.

FIG. 21 illustrates an example rundown converter dialog according to an embodiment of the present invention.

FIG. 22 illustrates an example ETLA search according to an embodiment of the present invention.

FIG. 23 illustrates an example graphical time sheet view according to an embodiment of the present invention.

### DETAILED DESCRIPTION OF THE PREFERRED EMBODIMENTS

### A. System Architecture Overview

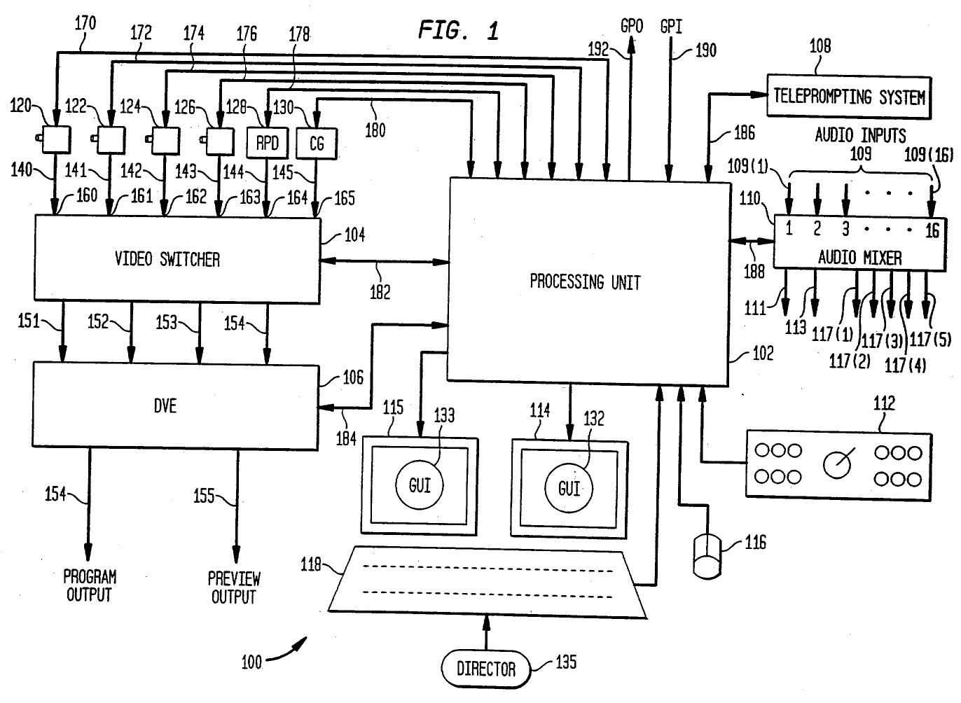

FIG. 1 illustrates, according to an embodiment of the present invention, an integrated video production system 100 for automating the execution of a show. Integrated video production system 100 is described in detail in commonly assigned U.S. patent application Ser. No. 10/200,776, filed Jul. 24, 2002, by Holtz et al., and entitled “Real Time Video Production System and Method,” (hereinafter referred to as the '776 application”). The disclosure of the '776 application is incorporated herein by reference as though set forth in its entirety. To facilitate in the understanding of the present invention, integrated video production system 100 will be briefly discussed herein with reference to FIG. 1.

As shown in FIG. 1, video production system 100, in a representative embodiment, includes a processing unit 102 in communication with a variety of video production devices. Such video production devices include, but are not limited to, a video switcher 104; a digital video effects device (DVE) 106; an audio mixer 110; a teleprompting system 108; video cameras and robotics (for pan, tilt, zoom, focus, and iris control) 120, 122, 124, and 126; a record/playback device (RPD) 128; and a character generator and/or still store 130. RPD 128 can be a video tape recorder/player (VTR), a video server, a virtual recorder, a digital audio tape (DAT) recorder, or any device that stores, records, generates or plays back via magnetic, optical, electronic, or any other storage media. Lines 170-188 represent logical communication paths between processing unit 102 and the video production devices 104-130 listed above. Each of these components are described in detail in the '776 application.

A video director 135 uses processing unit 102 to produce a show. In an embodiment, processing unit 102 displays graphical user interfaces (GUIs) 132 and 133 on display devices 114 and 115, respectively. In another embodiment, processing unit displays GUIs 132 and 133 together on a single display device.

GUIs 132 and 133 display graphical controls corresponding to the video production devices 104-130. Video director 135 uses a keyboard 118 and a mouse 116 to interact with the processing unit 102 by manipulating the graphical controls of GUI 132 and 133. In response to video director 135 activating a graphical control from GUI 132 or 133, processing unit 102 transmits a video production command to the video production device corresponding to the activated graphical control. In this manner, video director 135 centrally controls the operation of each of the video production devices.

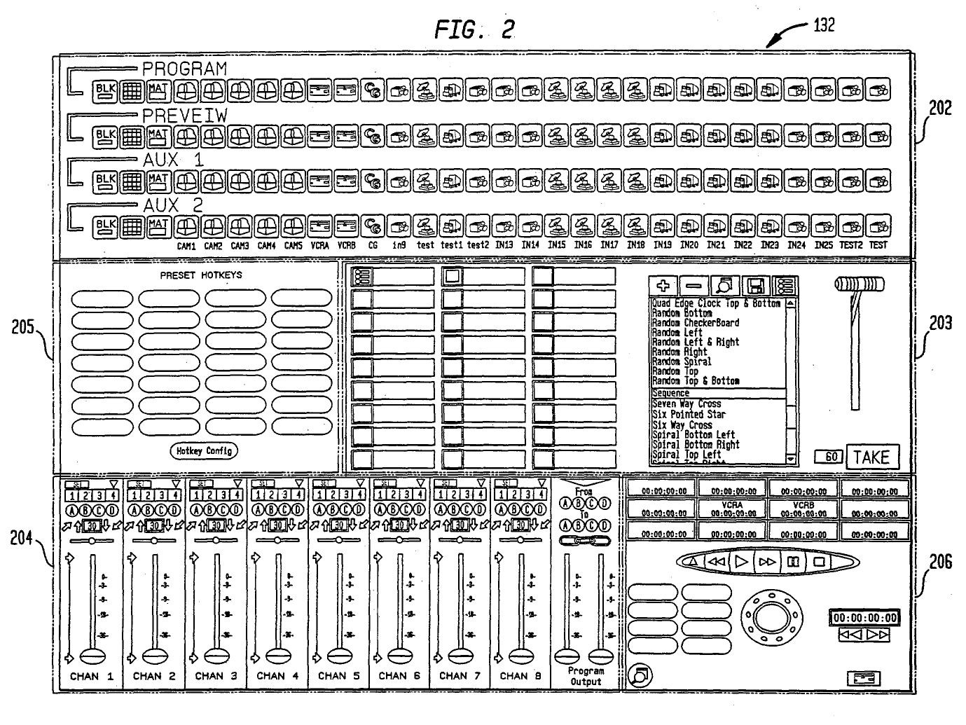

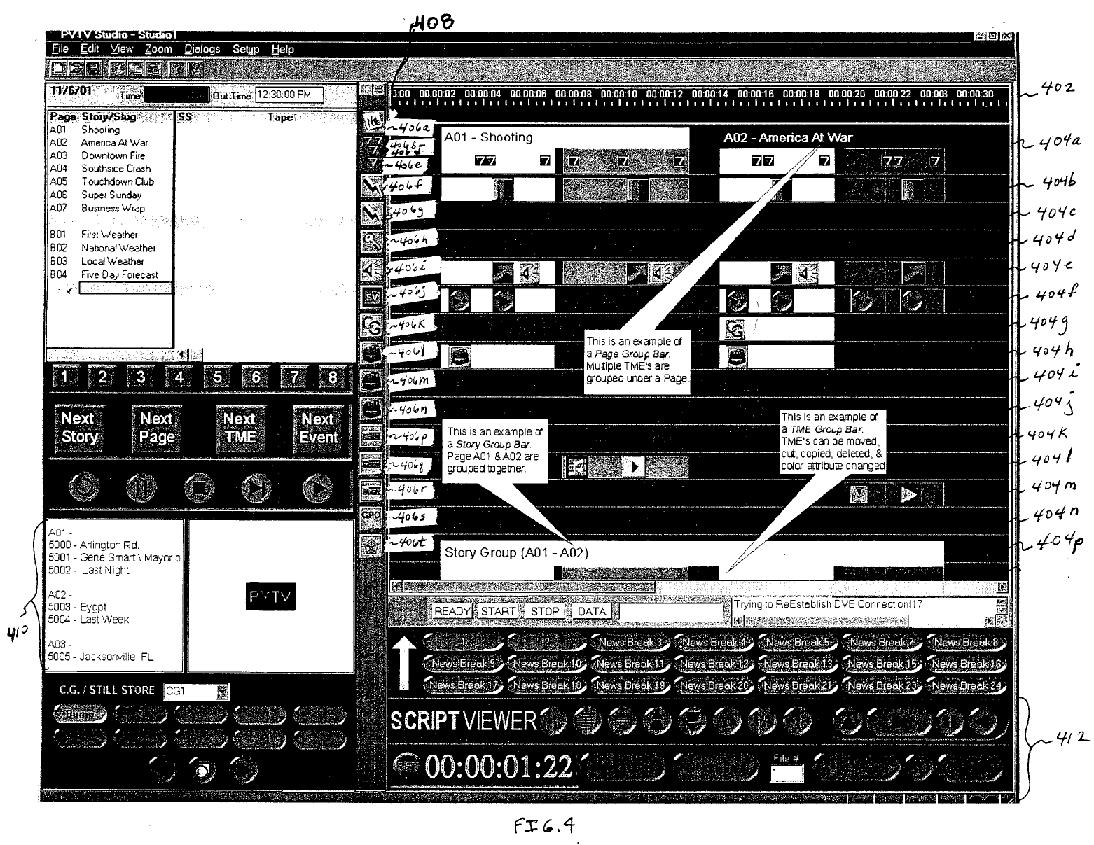

FIGS. 2 and 4 illustrate an embodiment of GUI 132 and an embodiment of GUI 133, respectively. GUI 132 includes video switcher graphical controls 202 for controlling video switcher 104 and DVE 106; audio mixer graphical controls 204 for controlling audio mixer 110; RPD graphical controls 206 for controlling up to twelve RPDs; camera graphical controls 205 for controlling one or more cameras that are in communication with processing unit 102; and DVE controls 203 for controlling DVE 106. GUI 132 is described in detail in the '776 application.

GUI 133 of FIG. 4 is an user-friendly graphical interface that enables the director (i.e., video director 135 from FIG. 1), or other personnel, to interact with the control system and make timely edits and revisions to the production as it is being filmed, videotaped, or broadcast. The graphical interface is an event-driven, timeline based application. The time sheet of the graphical interface has a timeline and control lines. The control lines are populated with various icons that are linked to the control system. The present invention includes a mechanism that improves the director's ability to change the order and grouping of the selected icons in response to timely changes to the rundown at various levels of granularity. The present invention also includes resynchronization and error correction routines for the altered time sheet. The enhanced time sheet of the present invention is described next in more detail.

### B. Time Sheet

FIG. 4 illustrates an embodiment of an interactive time sheet created by a timeline-based application of graphical user interface (GUI) 133, according to an embodiment of the invention. The time sheet includes a horizontal timeline 402 and one or more horizontal control lines 404a-404p. Automation control icons 406a-406t are positioned onto control lines 404a-404p at various locations relative to timeline 402, and configured to be associated with one or more video production commands and at least one video production device. FIG. 4 illustrates an embodiment of the time sheet after the placement of automation control icons 406a-406t onto control lines 404a-404p.

A timer (not shown) is integrated into timeline 402, and operable to activate a specific automation control icon 406a-406t as a timer indicator 408 travels across timeline 402 to reach a location linked to the specific automation control icon 406. As a result, video production system 100 would execute the video production commands to operate the associated video production device.

In regards to automation control icons 406a-406t, label icon 406a permits a director to name one or more segments or portions of a time sheet. In an embodiment, the director would drag and drop a label icon 406a onto control line 404a, and double click on the positioned label icon 406a to open up a dialogue box to enter a text description. The text would be displayed on the positioned label icon 406a.

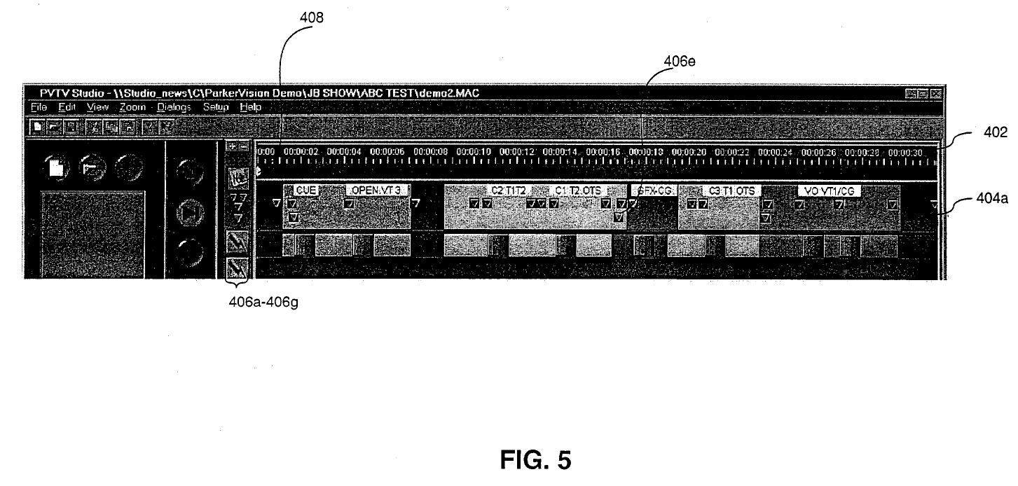

Control line 404a is also operable to receive a step mark icon 406b, a general purpose input/output (GPI/O) mark icon 406c, a user mark icon 406d, and an encode mark 406e. Encode mark 406e is described in detail below with reference to FIG. 5. Step mark icon 406b and GPI/O mark icon 406c are associated with time sheet step commands. The time sheet step commands instruct timer indicator or cursor 408 to start or stop running until deactivated or reactivated by the director or another video production device. For example, step mark icon 406b and GPI/O mark icon 406c can be placed onto control line 404a to specify a time when timer indicator 408 would automatically stop running. In other words, timer indicator 408 would stop moving across timeline 402 without the director having to manually stop the process, or without another device (e.g., a teleprompting system 108) having to transmit a timer stop command. If a step mark icon 406b is activated to stop timer indicator 408, timer indicator 408 can be restarted either manually by the director or automatically by another external device transmitting a step command. If a GPI/O mark icon 406c is used to stop timer indicator 408, timer indicator 408 can be restarted by a GPI or GPO device transmitting a GPI/O signal.

In an embodiment, step mark icon 406b and GPI/O mark icon 406c may be used to place a logical break between two segments on the time sheet. In other words, step mark icon 406b and GPI/O mark icon 406c are placed onto control line 440a to designate segments within a video production. One or more configuration files can also be associated with a step mark icon 406b and GPI/O mark icon 406c to link metadata with the designated segment.

Transition icons 406f-406g are associated with automation control commands for controlling video switching equipment. Thus, transition icons 406f-406g can be positioned onto control lines 404b-404c to control one or more devices to implement a variety of transition effects or special effects into a video production. Such transition effects include, but are not limited to, fades, wipes, DVE, downstream keyer (DSK) effects, and the like. DVE includes, but is not limited to, warps, dual-box effects, page turns, slab effects, and sequences. DSK effects include DVE and DSK linear, chroma and luma keyers.

Keyer control icon 406h is positioned on control line 404d, and used to prepare and execute keyer layers either in linear, luma, chroma or a mix thereof for preview or program output. The keyers can be upstream or downstream of the DVE.

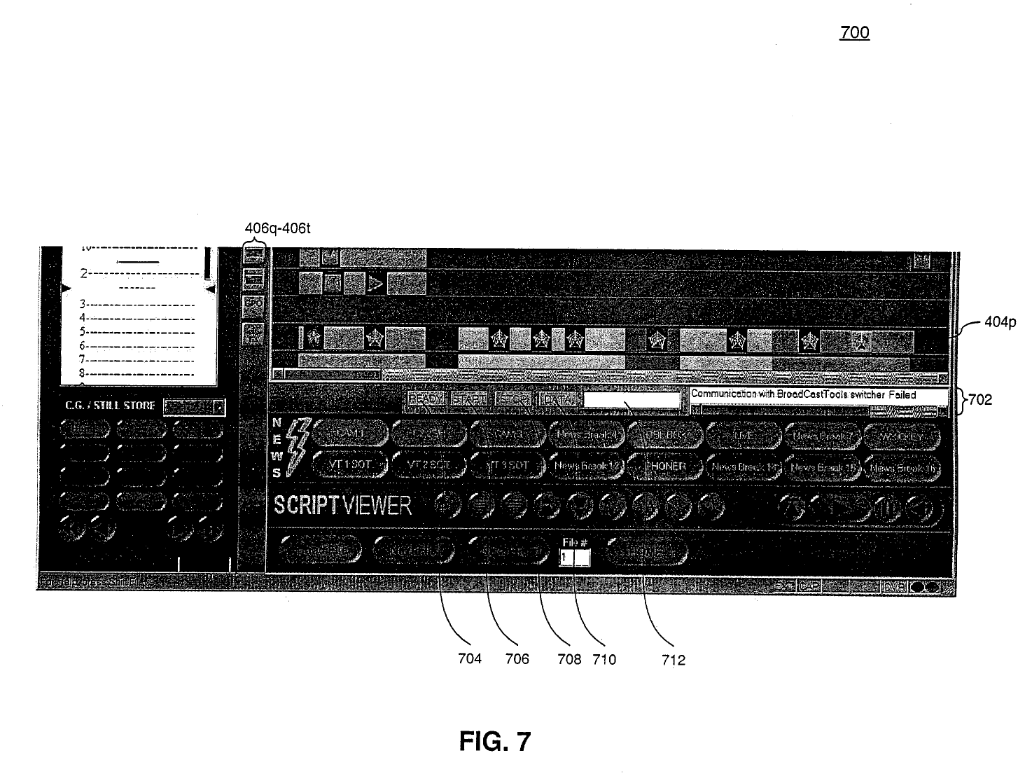

Audio icon 406i can be positioned onto control line 404e and is associated with commands for controlling audio equipment, such as audio mixers, digital audio tape (DAT), cassette equipment, other audio sources (e.g., CDs and DATs), and the like. Teleprompter icon 406j can be positioned onto control line 404f and is associated with commands for controlling a teleprompting system to integrate a script into the timeline. Character generator (CG) icon 406k can be positioned onto control line 404g and is associated with commands for controlling a CG or still store to integrate a CG page into the timeline. Camera icons 406l-406n can be positioned onto control lines 404h-404j and are associated with commands for controlling the movement and settings of one or more cameras. VTR icons 406p-406r can be positioned onto control lines 404k-404m and are associated with commands for controlling VTR settings and movement. GPO icon 406s can be positioned onto control line 404n and is associated with commands for controlling GPI or GPO devices. Encode object icon 406t can be positioned onto control line 404p and is associated with encoding commands which are described in detail below with respect to FIG. 7.

User mark icon 406d is provided to precisely associate or align one or more automation control icons 406a-406c and 404e-404t with a particular time value. For example, if a director desires to place teleprompter icon 406j onto control line 404f such that the timer value associated with teleprompter icon 406j is exactly 10 seconds, the director would first drag and drop user mark icon 406d onto control line 404a at the ten second mark. The director would then drag and drop teleprompter icon 406j onto the positioned user mark icon 406d. Teleprompter icon 406j is then automatically placed on control line 404f such that the timer value associated with teleprompter icon 406j is ten seconds. In short, any icon that is drag and dropped onto the user mark 406d is automatically placed on the appropriate control line and has a timer value of ten seconds. This feature helps to provide multiple icons with the exact same timer value.

After the appropriate automation control icons 406 have been properly position onto the time sheet, the time sheet can be stored in a file for later retrieval and modification. Accordingly, a show template or generic time sheet can be re-used to produce a variety of different shows. A director could recall the show template by filename, make any required modifications (according to a new rundown sheet), and save the time sheet with a new filename.

As described above, one video production device is teleprompting system 108 (FIG. 1) that includes a processing unit and one or more displays for presenting a teleprompting script (herein referred to as “script”) to the talent. In an embodiment, teleprompting system 108 is the SCRIPT Viewer™, available from ParkerVision, Inc. As described in the '776 application, teleprompting system 108 can be used to create, edit, and run scripts of any length, at multiple speeds, in a variety of colors and fonts. In an embodiment of the present invention, teleprompting system 108 is operable to permit a director to use a text editor to insert video production commands into a script (herein referred to as “script commands”). The text editor can be a personal computer or like workstation, or the text editor can be an integrated component of time sheet GUI 133. Referring to FIG. 4, text window 410 permits a script to be viewed, including script commands. Script controls 412 are a set of graphical controls that enable a director to operate the teleprompting system and view changes in speed, font size, script direction and other parameters of the script in text window 410.

The script commands that can be inserted by teleprompting system 108 include a cue command, a delay command, a pause command, a time sheet step command, and an enhanced video command. The present invention is not limited to the aforementioned script commands. As would be apparent to one skilled in the relevant art(s), commands other than those just listed can be inserted into a script.

FIG. 5 illustrates the top region of GUI 133 (FIG. 4) to provide a view of control line 404a. Control line 404a is used to enter icons 406a-406d that are associated with step commands and icon alignment commands, as discussed above. Another automation control icon that can be placed on control line 404a is encode mark 406e. In an embodiment, encode mark 406e operates like a Web Mark™ developed by ParkerVision, Inc. During the encoding process, encode mark 406e identifies a distinct segment within a video production. As timer indicator 408 advances beyond encode mark 406e, the encoding system is instructed to index the beginning of a new segment.

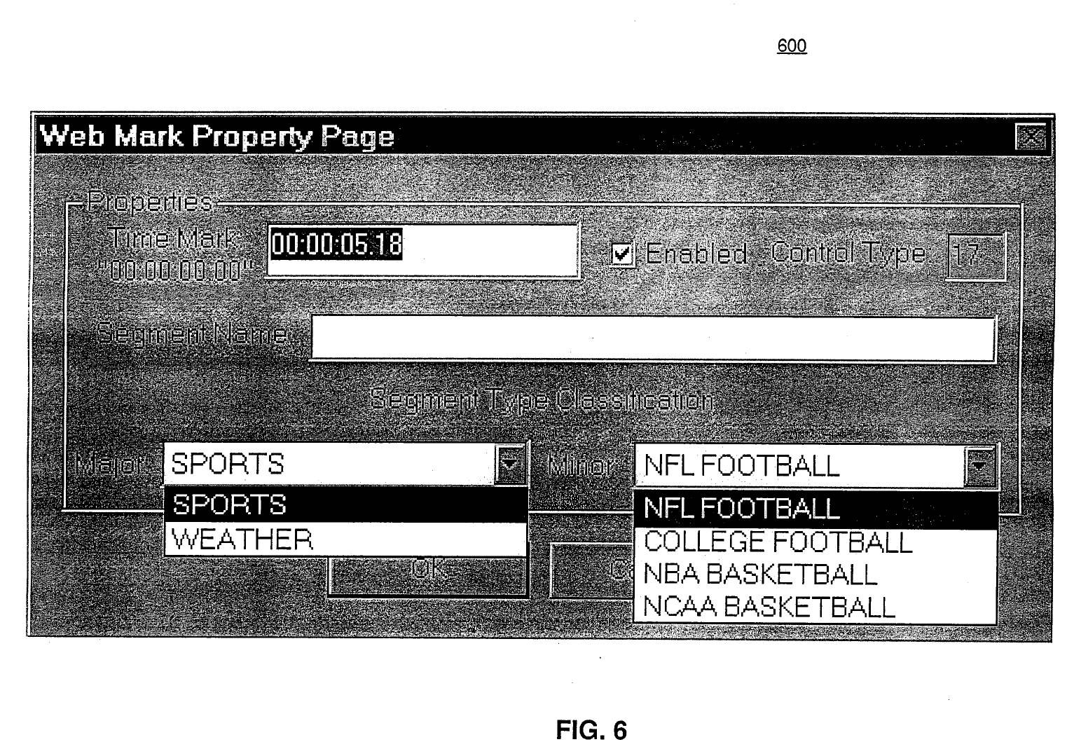

In an embodiment, the properties of each encode mark 406e are established by activating encode mark 406e to open a configuration GUI. FIG. 6 illustrates an embodiment of an encode mark configuration GUI 600. GUI 600 can be used to set the time for initiating the encoding commands associated with encode mark 406e. The time can be manually entered or is automatically entered at the time of placing encode mark 406e on control line 404a. GUI 600 also permits an operator to designate a name for the segment, and specify the segment type classification. Segment type classification includes a major and minor classification. For example, a major classification or topic can be sports, weather, headline news, traffic, health watch, elections, and the like. Exemplary minor classifications or category can be local sports, college basketball, NFL football, high school baseball, local weather, national weather, local politics, local community issues, local crime, editorials, national news, and the like. Classifications can expand beyond two levels to an unlimited number of levels for additional granularity and resolution for segment type identification and advertisement targeting. In short, the properties associated with each encode mark 406e provide a set of metadata that can linked to a specific segment. These properties can be subsequently searched to identify or retrieve the segment from an archive.

FIG. 7 illustrates the bottom region of GUI 133 (FIG. 4) to provide a view of control line 404p. Control line 404p is used to enter icons automation control icon 406t that is associated with encoded transmission commands. The encoded transmission commands instructs the encoding system to start or stop the encoding process until deactivated or reactivated by an operator or another video production device.

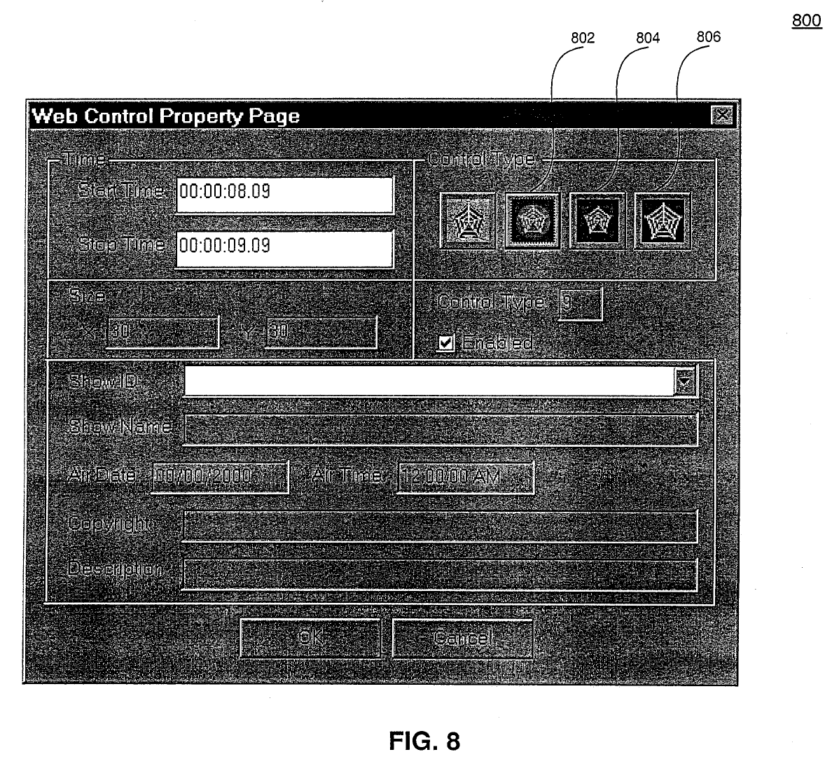

Encode object icons 406t are placed on control line 404p to produce encode objects. In an embodiment, encode object icon 406t operates like Web Objects™ developed by from ParkerVision, Inc. FIG. 8 illustrates an embodiment of a configuration GUI 800 that can be used to set the searchable properties of each encode object icon 406t. In this embodiment, start stream object 802, data object 804 and stream stop object 806 are three types of encode object icons 406t that can be used. Start stream object 802 initializes the encoding system and starts the encoding process. In comparison with encode mark 406e, start stream object 802 instructs the encoding system to start the encoding process to identify a distinct show, whereas encode mark 406e instructs the encoding system to designate a portion of the video stream as a distinct segment. The metadata contained in start stream object 802 is used to provide a catalog of available shows, and the metadata in encode mark 406e is used to provide a catalog of available show segments.

Data object 804 is used to identify auxiliary information to be displayed with the video stream. As described in detail below, auxiliary information includes graphics or text in a HTML page and is referenced in GUI 800 by its URL address.

Stream stop object 806 is used to stop the encoding process and designate the end of a distinct show. Once timer indicator 408 passes the stream stop object 806, the encoding system would start the post-production processes, such as, including indexing segments, cataloging segments, pacing script, and the like.

The encoding start and stop times can be manually entered into GUI 800 or automatically updated upon placement of start stream object 802, data object 804 or stop stream object 806 onto control line 404p. GUI 800 also permits one to designate a show identifier, show name or description for the production. Other properties include the scheduled or projected air date and air time for the production. A copyright field is provided to specify any restrictions placed on the use or re-use of a specific show or show segment. For example, a broadcasting studio may not have a license to transmit a specific content on the Internet, but may have permission to provide the content over a private network or the air waves. The content can be restricted for educational uses, single broadcast, transmissions to designated clients, and the like. The appropriate component of system 100 (e.g., enhanced video server 115, streaming server 125, IM server 130, etc.) would verify the copyright field prior to streaming the content to an enhanced video client 120.

Referring back to FIG. 4 and FIG. 7, as timer indicator 408 moves or passes over each encode object icon 406t (i.e., start stream object 802, data object 804 or stop stream object 806), the associated encoding commands are automatically processed. However, the present invention enables an operator to manually alter the encoding process during execution. In particular, encoding control region 702 provides a set of graphical controls that enable an operator to modify the encoding process. The encoding graphical controls include a ready control 704, start control 706, stop control 708, and data control 710.

Ready control 704 has an “activate” state and “de-activate” state. As such, ready control 704 is operable to send “read” or “not read” commands to timer indicator 408 depending on whether ready control 704 is operating in an activate or de-activate state, respectively. In an embodiment, when ready control 704 is operating in an activate state, timer indicator 408 signals the encoding system to read and process the associated encoding commands as timer indicator 408 passes each encode object icon 406t and encode mark 406e. Similarly, when deactivated, ready control 704 instructs timer indicator 408 to signal the encoding system to not read the encoding commands associated with each encode object icon 406t and encode mark 406e. Therefore, when ready control 704 is deactivated, ready control 704 allows directors to perform test runs to preview a show prior to the broadcast. A preview mode is desirable to allow directors to check the show to make sure that the correct sources and transitions are selected.

Start control 706 is used to initiate the encoding system manually. In an embodiment, start control 706 is operable to manually override a deactivate state established by ready control 704 or stop control 708 (discussed below). Start control 706 can be used to manually activate the encoding process to send video streams to streaming server 125 that contain time-sensitive production elements, such as a breaking news element, or other manually prepared video productions.

Stop control 708 is operable to deactivate the encoding process and stop transmissions to streaming server 125. Stop control 708 would deactivate an encoding process initiated by either ready control 704 or start control 706. Stop control 708 provides directors with the ability to stop the encoding system manually to avoid airing any unauthorized content as an example.

Data control 710 is used to enter auxiliary information and link the information to a specific segment or an entire show. The auxiliary information is entered by typing the URL reference in reference window 712 and activating data control 710. Accordingly, auxiliary information can be entered via the configuration GUI 800 for data object 804 or reference window 712. Data control 710 enables directors to enter URLs at any time during manual operations.

As described above, GUI 133 of FIG. 4 is a user-friendly graphical interface that enables the director (i.e., video director 135 from FIG. 1), or other personnel, to interact with the control system and make timely edits and revisions to the production as it is being filmed, videotaped, or broadcast. In an embodiment of GUI 133, the time sheet includes a horizontal timeline 402 and one or more horizontal control lines 404a-404p. In particular, the time sheet section of GUI 133 provides the video director (or user) with a more efficient way of maneuvering around the time sheet. This is accomplished by allowing the user to group and/or manipulate elements (or icons) on different levels, increase the speed at which elements are triggered from the time sheet and increase the user's flexibility to define a custom time sheet view.

To facilitate the understanding of the present invention with regards to the time sheet section of GUI 133, the following definitions are provided.

Hierarchical Grouping—a series of layered collections of objects (e.g., icons 406a-406t discussed above) within a system.

Layer one of the various levels of collections.

Object—a single icon or element dropped onto the timeline or time sheet of GUI 133. Example icons are GP I/O mark icon 406c, a DVE icon, audio icon 406i, and so forth.

Event—objects (icons) placed between GP I/O mark icons 406c, which execute one element of the video production.

TME (Transition Macro Elements)—a collection of one or more objects or events or icons on the time sheet.

Page—a collection of one or more TME's on the time sheet. (Newsroom systems may define a page as a single line on the rundown or as a unique slug within the rundown.)

Story—a collection of one or more pages on the time sheet. On newsroom systems, a single line or slug or multiple lines or slugs may make up a story. Input from the user at some point may be entered.

Show—a group of one or more stories on the time sheet. Any object on the time sheet is a show. When the time sheet is saved, it may be saved as a show.

Layout—the layout maintains user definable time sheet views (visible rows, grouping view), LBN pages, Camera Preset hotkeys, CG/SS hotkeys, the Switcher Layout, Audio Layout (Audio Presets, Page Setup, Aux Setup, Channel Setup), position and visibility of GUI windows.

Layer Handles—a graphical bar displayed on the time sheet that corresponds to a “Layer”, which gives the ability to grab and maneuver the specific “Layer”.

ITME (Intelligent Transition Elements)—a series of one or more objects (or icons) on the time sheet that contains link information to other objects (or icons).

Class ID (Major ID)—defines the module with which the present invention will communicate. (DVE, Audio, Keyers, ScriptViewer, Cameras, Machine Control, CG/SS, GPO, Web, etc.).

NCS (Newsroom Computer System)—the newsroom management software that creates show rundowns. The rundowns become the running order of stories and events within a show.

Rundown Converter—the intelligent intermediary between a NCS and video production system 100 (FIG. 1).

### C. Hierarchical Group Levels

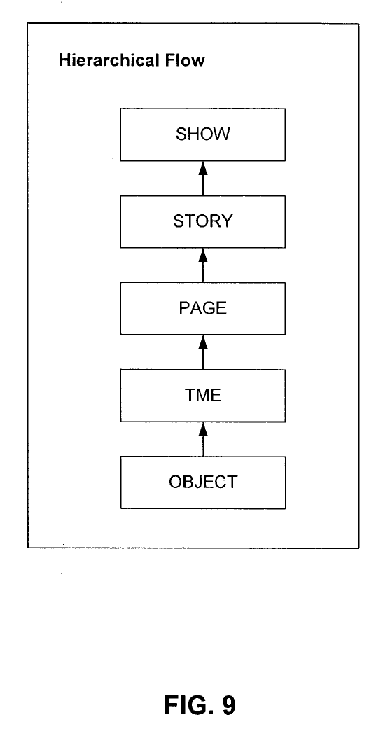

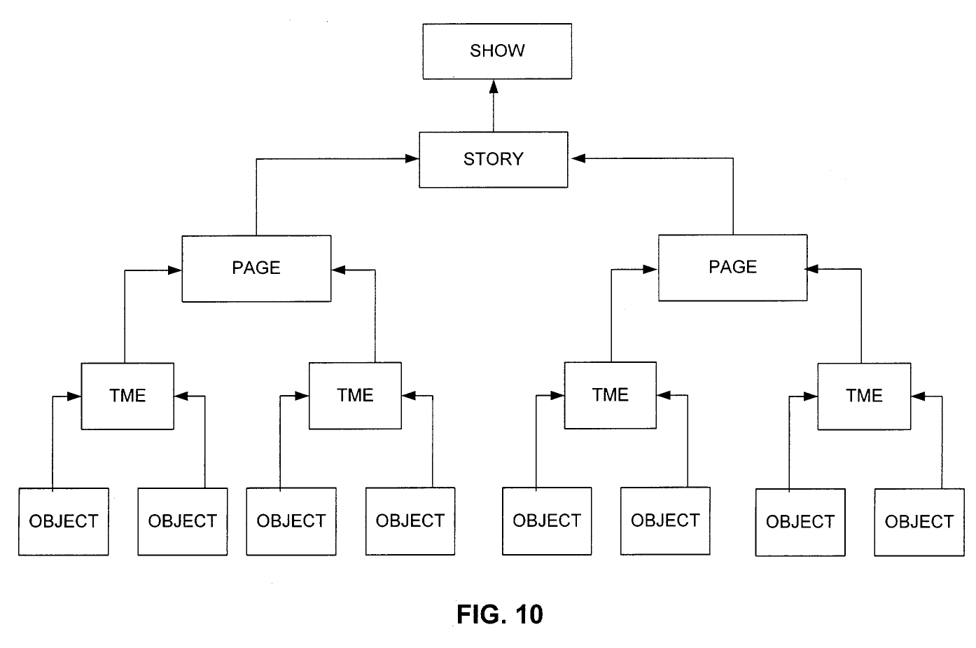

The present invention defines a hierarchy of at least five (5) group levels for time sheet of GUI 133. The hierarchy of the group levels is illustrated in FIG. 9. FIG. 9 illustrates that the object level is at the bottom of the hierarchy and the show level is at the top of the hierarchy. Moving from the object level to the show level, the other levels include a TME level, a page level and a story level. This hierarchy is further illustrated in FIG. 10.

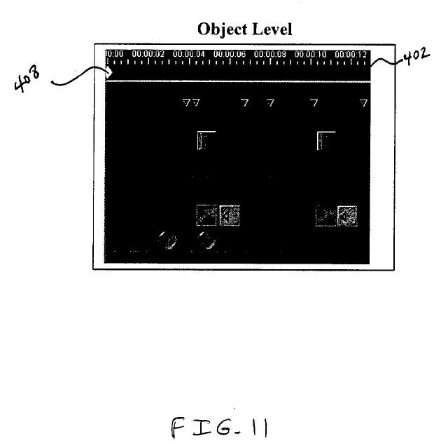

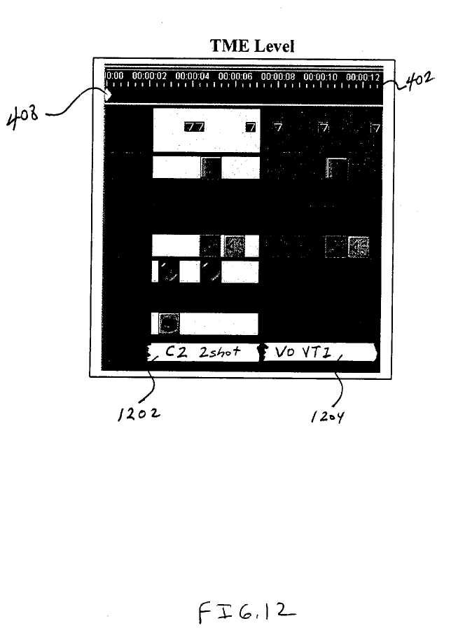

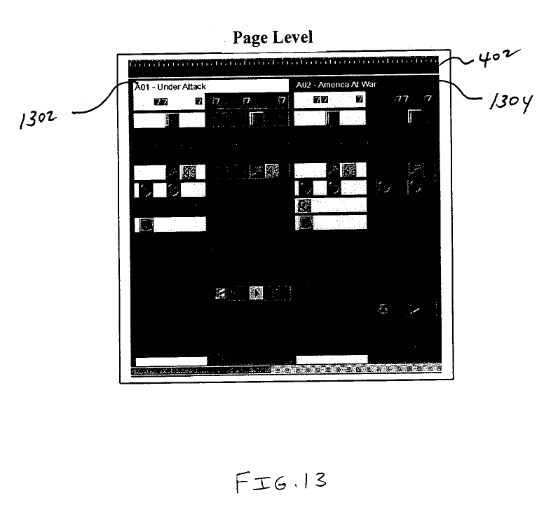

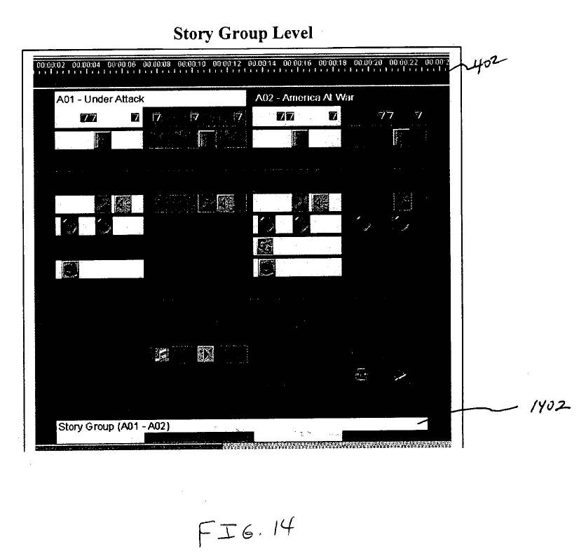

FIG. 10 illustrates that one or more objects (or icons) make up a TME, one or more TMEs make up a page, one or more pages make up a story and one or more stories make up a show. The present invention provides for group level GUIs that illustrate each of these group layers in the time sheet of GUI 133. The group layer GUIs are illustrated in FIGS. 11-14. Object group layer GUI is illustrated in FIG. 11. TME group layer GUI is illustrated in FIG. 12. Page group layer GUI is illustrated in FIG. 13. Story group layer GUI is illustrated in FIG. 14. Each of these group layer GUIs will be described in more detail below

### D. Hierarchical Flow

Several rules apply to the group layer GUIs of the time sheet for GUI 133 of the present invention. First, when an object (or icon) is dropped on the time sheet, it is by default a member of all group layers. For example, the object that is dropped is part of the object, TME, page, story and show layers. Additional objects can be placed within any level above the object level. An object dropped in the previous object layer, TME layer is a member of the first object layer, TME layer, page layer, story layer and show layer. An object dropped in the previous object layer, page layer is a new TME layer, but a member of the first object layer, page layer, story layer and show layer.

Objects can be gathered under the TME level, TME's can be gathered under the page level, pages an be gathered under the story level, and everything is under the show level.

A show is the container for everything, which can be divided into various stories. A story can contain multiple page layers, a page layer can contain multiple TME layers, and a TME layers can contain multiple object layers.

The present invention provides graphical layer handles for easier manipulation of the TME, page and story group layers. Referring to FIG. 12 and example TME layer GUI, two handles are illustrated including handle 1202 and handle 1204. In FIG. 13 and example page layer GUI, two handles are illustrated including handle 1302 and handle 1304. In FIG. 14 and example story layer GUI, one handle 1402 is illustrated.

Each handle shown in FIGS. 12-14, is a graphical bar that stretches from the beginning to the end of the layer. In an embodiment of the invention, a handle should not extend beyond the right edge of the layer. The handles in the page layer may be titled with the slug name from the newsroom system for that page. For example, in FIG. 13, the slug name for handle 1302 is “A01-Under Attack” and the slug name for handle 1304 is “A02-America at War.”

A TME layer in the time sheet of GUI 133 can be “grabbed” and manipulated from anywhere in the TME layer. Labels can be placed on any control line 404a-404p (FIG. 4) of the time sheet. In an embodiment of the invention, a handle should not extend beyond the right edge of the TME layer. Grouping rules provided by the present invention are described next.

The present invention provides a number of grouping rules. One rule is that the left edge of a TME layer, the page layer and the story layer are the same. Another rule is that like layers do not overlap. For example, a TME layer should not overlap another TME layer. A page layer should not overlap another page layer. A story layer should not overlap another story layer. Another rule is that any object placed in a TME layer is always at least one frame to the right of the left edge of the TME layer. Yet another rule is all prep (pre-process) times to the left of an object extend the TME layer to the left (the number of frame for prep +1 frame). Another rule is that TME layers are spaced two (2) frames apart by default. The minimum spacing is one frame. The present invention also allows for user definable TME layer spacing settings. Another rule is that page and story layers are spaced three (3) frames apart by default. The minimum spacing is one frame. The present invention also allows for user definable page and story layer spacing settings. The present invention is not limited to the aforementioned rules. As would be apparent to one skilled in the relevant art(s), rules other than those just listed may be enforced by the invention. The time sheet setup provided by the present invention is described next.

### E. Time Sheet Setup Dialogs

A goal of the present invention is to provide the user with the maximum flexibility to define the look and layout of the time sheet of GUI 133. The present invention provides this maximum flexibility without negatively affecting the performance of video production system 100 (FIG. 1) and/or requiring the user to make massive manual changes to a large library of TMEs, LBNs, shows, and so forth. The time sheet setup includes, but is not limited to, four dialogs. These dialogs: (1) a timeline speed dialog; (2) a time sheet row setup dialog; (3) a time sheet layout setup dialog; and (4) a time sheet pre-process (“prep”) setup dialog. Each of these are described in more detail below.

1. Timeline Speed Dialog

The timeline speed dialog includes a slider control that allows the user to change the speed at which timer indicator 408 travels across timeline 402 (FIG. 4).

2. Time Sheet Row Setup Dialog

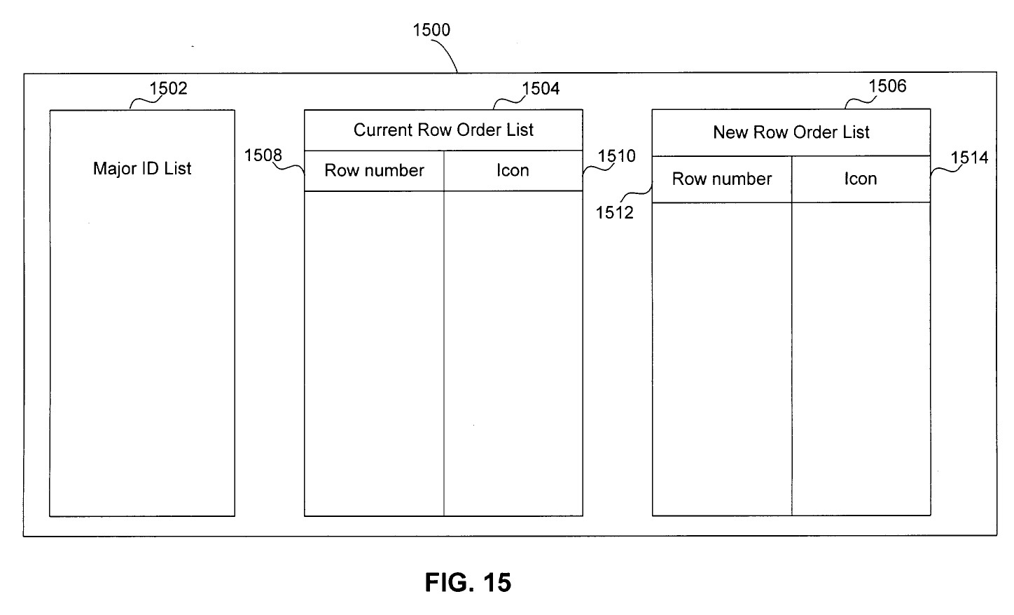

As described above with reference to FIG. 4 and GUI 133, the time sheet includes a horizontal timeline 402 and one or more horizontal control lines 404a-404p. Automation control icons 406a-406t are positioned onto control lines 404a-404p at various locations relative to timeline 402, and configured to be associated with one or more video production commands and at least one video production device. The present invention provides a time sheet row setup dialog that includes three lists, as described with reference to FIG. 15. The time sheet row setup dialog may be password protected.

Referring to FIG. 15, time sheet row setup dialog 1500 includes three main lists. These three lists include a major ID list 1502, a current row order list 1504 and a new row order list 1506. Current row order list 1504 includes two columns, a row number 1508 and an icon 1510. New row order list 1506 also includes two columns, a row number 1512 and an icon 1514. Each of these are described in more detail next.

Major ID list 1502 contains icons representing each class ID (or major ID) with which a row can be assigned (e.g., class Ids for TME building).

Current row order list 1504 includes the row number 1508 and icon 1510 columns. New row order list 1506 includes the row number 1512 and icon 1514 columns. Here, the user may drag icons from the major ID list 1502 and drop them on the new row order list 1506. In addition, the user may drag icons from the current row order list 1504 and drop them on the new row order list 1506.

The user may also create a row when an icon is dragged from the major ID list 1502 and dropped on the new row order list 1506. Here, the icon is automatically placed in the first available list index of column icon 1504 and the row number is assigned based on its position in the list.

When a user drags an icon (or item) from the current row order list 1504 and drops it on the new row order list 1506 (and not on an existing icon in new row order list 1504), the icon is placed at the same list index as the list index in the current row order list 1504. In addition, the icon is automatically “mapped” current row order to new row order. If another icon already exists at that list index, then that icon is moved to the first available list index that has not been “mapped” and the icon from the current row order is placed at the same list index as the current row order list index and is automatically “mapped.”

In an embodiment of the present invention, at least one list icon for each active TME building class ID should be created (e.g., DVE, audio, keyers, script viewer, cameras, machine control, CG/SS, GPO, web, and so forth).

The present invention allows the user to replace a row in time sheet row setup dialog 1500 if an icon from major ID list 1502 is dropped on an assigned list icon that is not “mapped.” Here, the dropped icon replaces the existing icon. If the icon is dropped on a “mapped” icon, then a warning dialog may appear to inform the user that mapped icon cannot be replaced.

The present invention allows the user to delete a row in time sheet row setup dialog 1500 by right clicking on a icon in column icon 1514 in new row order list 1506 and then by executing a “delete row command.” When a row is deleted, all non-mapped icons below the deleted row are re-ordered by filling in the available non-mapped rows.

The user can insert a row in time sheet row setup dialog 1500 by right clicking on a icon and then by executing a “insert row command.” When a row is inserted, all non-mapped icons re-order down filling in the available non-mapped rows. If the list icon selected is a “mapped” icon, then a warning message may appear to warn the user that mapped rows cannot be moved.

The user can move rows in time sheet row setup dialog 1500 by holding the left button of the mouse to drag an icon. When the dragged icon is dropped onto another non-mapped row, the icon dropped (if not mapped) and all non-mapped icons below it re-order. Here, the dragged icon replaces the dropped icon. If a list icon is dragged and dropped onto an empty row, then that icon is placed on that row.

The present invention also allows for row mapping in time sheet row setup dialog 1500. Here, when icons are dragged from current row order list 1504 to new row order list 1506, the mapping is automatic since the row placement is the same. To map a current row order list icon to a different row of the new row order list 1506, the user may hold the left button of the mouse down to drag an icon from the current row order list 1504 and drop it on the row in the new row order list 1506 that the user wishes to associate the icon with. The color of the row number entry that is affected is changed to red (or any other predetermined color) and this indicates it is no longer available for selection. The present invention then draws a line from the current row order list icon to the new row order list icon to indicate the mapping relationship. Once an icon in either list is mapped, that icon is no longer available to be mapped to any other icon.

If the user wishes to un-map a mapped icon, he or she can select any mapped icon from the current row order list 1504 or the new row order list 1506 and right mouse click to select the “re-map row command.” The line connecting the two icons is erased and the color of the affected row number entry is changed from red to black (or any other predetermined color). The relationship between the two icons is severed and each icon is available to be re-mapped.

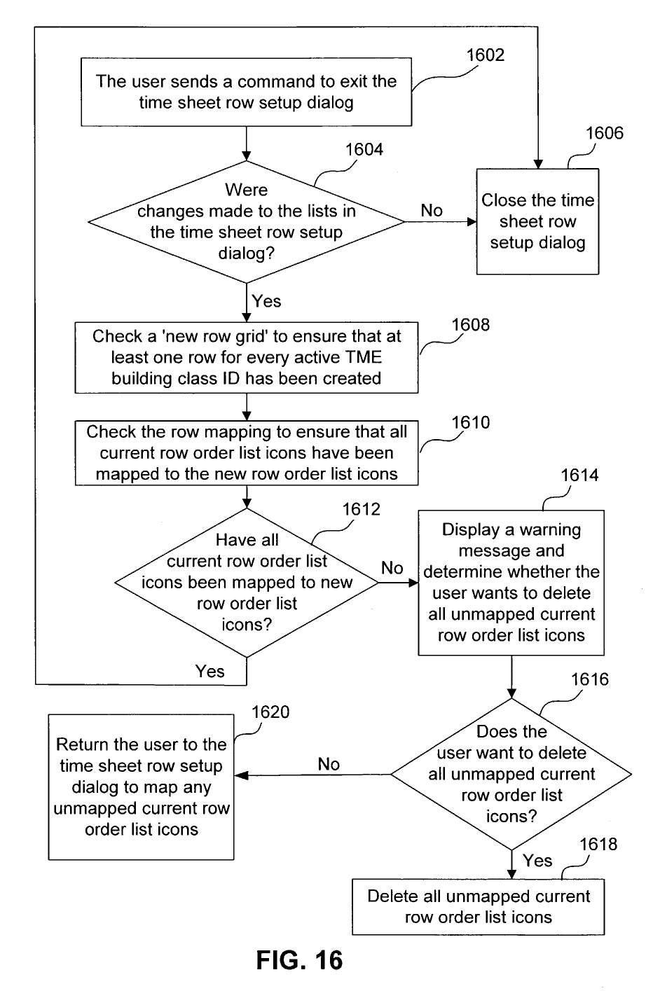

An example operation of the present invention upon receiving a command from the user to exit time sheet row setup dialog 1500 is illustrated in the flowchart of FIG. 16. In step 1602, the user sends a command to exit the time sheet row setup dialog 1500. Control then passes to step 1604.

In step 1604, the present invention determines whether changes were made to the lists in the time sheet row setup dialog 1500. The lists include major ID list 1502, current row order list 1504 and new row order list 1506. If the outcome of step 1604 is negative, then control then passes to step 1606 where the time sheet row setup dialog 1500 is closed. At this point the flowchart in FIG. 16 ends. Alternatively, if the outcome of step 1604 is positive, then control passes to step 1608.

In step 1608, the present invention checks a ‘new row grid’ to ensure that at least one row in the lists of time sheet row setup dialog 1500 has been created for every active TME building class ID. Control then passes to step 1610. In step 1610, the present invention checks the row mapping to ensure all current row order list icons (i.e., column icon 1510) have been mapped to new row order list icons (i.e., column icon 1514). Control then passes to step 1612.

In step 1612, if all current row order list icons have been mapped to new row order list icons, then control passes to step 1606 where the time sheet row setup dialog 1500 is closed. The flowchart in FIG. 16 ends at this point. Alternatively, control passes to step 1614.

In step 1614, a warning message is given that not all rows have been mapped. Here, the TME library may be affected if all current row order list icons are not either mapped or deleted. The present invention provides the user with the opportunity to delete all urnapped current row order list icons. Control then passes to step 1616.

In step 1616, if the user wants to delete all unmapped current row order list icons, the control passes to step 1618 where all unmapped current row order list icons are deleted and the flowchart in FIG. 16 ends. Alternatively, control passes to step 1620.

In step 1620, the user is returned to the time sheet row setup dialog 1500 to map any unmapped current row order list icons. The flowchart in FIG. 16 ends at this point.

Once all current row order list icons are either mapped or deleted, the present invention assigns a new row setup GUID. Once the new row setup GUD is assigned, the present invention opens a dialog to update the TME library. The update begins and the TME Library is searched. Each object, using the “new row order” map, replaces the old row number with the new row number and replaces the old Row Setup GUID with the new Row Setup GUID. If the old row number was not mapped to the New Row Order, then the object is deleted from the TME. Upon completion of the TME Library update, the user is prompted, “Do you wish to update another TME Library?” If the answer is “Yes”, then the “Update TME Library” dialog is opened and the update process is repeated for the new selected library. If the answer is “No”, then the dialog is closed and the process is complete.

A copy of the Old Row Order, New Row Order, Mapping and Row Setup GUID is automatically saved by the present invention. The Old Row Order can be recalled from a menu item called “Restore Old Row Order”. Here, the current state is replaced with the saved Old Row Order, New Row Order, Mapping and Row Setup GUID. This enables the updating of a TME Library from the last know state to the current row setup. The third dialog included in the time sheet setup is described next.

3. Time Sheet Layout Setup Dialog

The time sheet layout setup dialog of the present invention allows the user to define: (1) the spacing of TMEs, pages and stories; (2) visible rows on the time sheet of GUI 133; (3) the layering view of the object, TME, page and story group levels; (4) the LBN pages loaded; (5) the camera preset hot keys loaded; (6) the CG/SS hot keys loaded; (7) the switcher layout; (8) the audio layout (audio presets, page setup, aux setup, channel setup); (9) the position and visibility of the different GUI windows, and so forth. The present invention is not limited to the aforementioned features of the time sheet layout setup dialog.

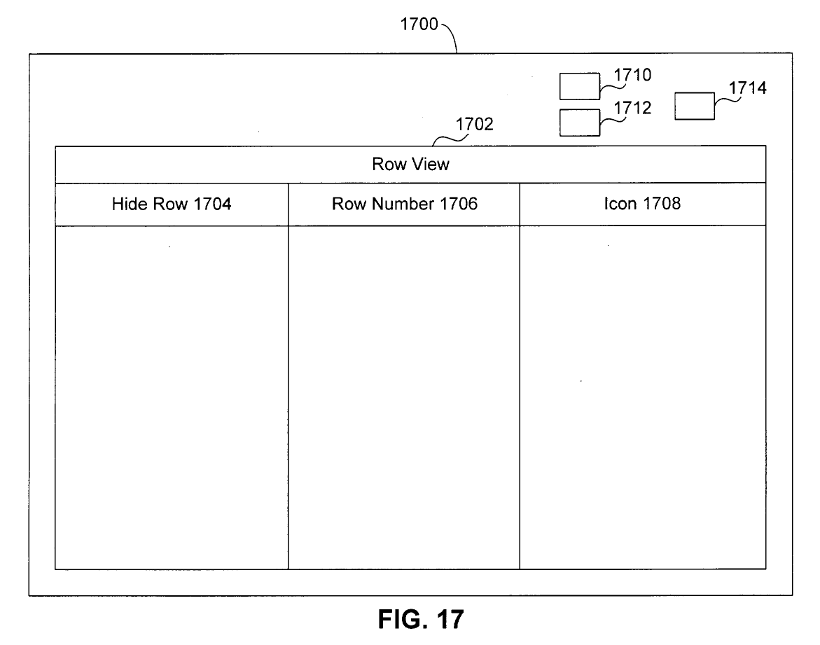

An embodiment of the time sheet layout setup dialog 1700 is shown in FIG. 17. Time sheet layout setup dialog 1700 includes a table 1702 entitled “row view” that includes a three-column list. The three-column list includes a hide row 1704, a row number 1706 and an icon 1708. Dialog 1700 also includes a check box 1710 to allow the user to save the layout with a default window position. In addition, dialog 1700 includes a check box 1712 to allow the user to save the layout with the current window positions. Dialog 1700 also includes a check box 1714 to allow the user to save the layout.

Referring to table 1702 in FIG. 17, the present invention allows the user to check the “hide row” box (in hide row 1704) for each row (in row number 1706) the user wishes to hide in the time sheet of GUI 133. Alternatively, the user can un-check the “hide row” box for each row the user wants visible in the time sheet of GUI 133.

As mentioned above, dialog 1700 includes a check box 1710 to allow the user to save the layout with a default window position, a check box 1712 to allow the user to save the layout with the current window positions, and a check box 1714 to allow the user to save the layout. In the present invention, when a layout is saved various modules each load setup files. For example, a switcher module can load a switcher setup file, an audio module can load an audio setup file, a LBN module can load LBN pages, a camera preset module can load camera preset pages, and so forth. When video production system 100 (FIG. 1) is started, default setup files are loaded for each module. When a layout is saved, a setup file for each module's current setup is saved with the same name as the layout file name. In addition the current row view is saved with the layout and, depending on which option is selected (Save Layout with default window positions or Save Layout with current window positions), the modules (position and visibility) is saved with the layout.

The user may recall a layout by selecting a File/Load Layout menu. The invention allows the user to locate and select a layout to load. The fourth dialog included in the time sheet setup is described next.

4. Time Sheet Pre-process (“Prep”) Setup Dialog

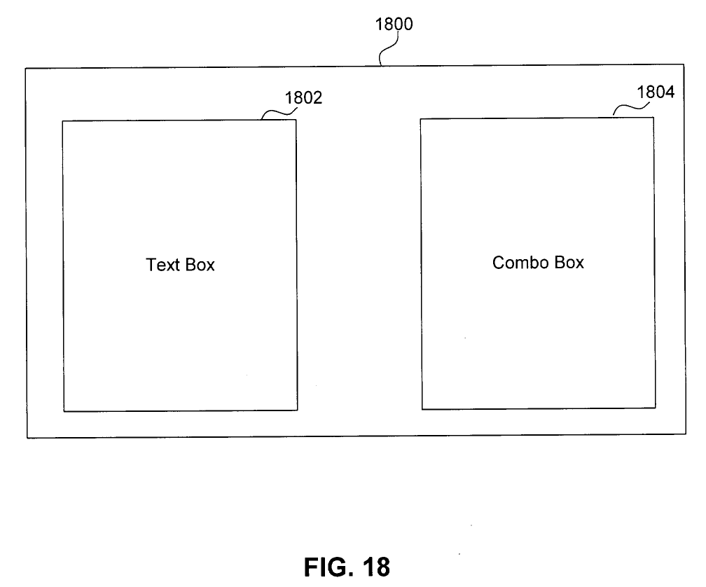

The timeline prep setup allows the user to assign the left edge trigger for prep (pre-process) objects or icons. An embodiment of the timeline prep setup dialog 1800 is shown in FIG. 18 and includes a text box 1802 and a combo box 1804. Text box 1802 contains the prep number (the number of frames to the left of the icon in time sheet of GUI 133 that pre-process will occur). Combo box 1804 contains a list of icons that are defined to have prep (pre-process) attributes. One prep number can be assigned for all prep objects by selecting “ALL” in the first selection in the list. Examples of prep icons include, but are not limited to, a digital video effects device (DVE) icon (not shown in FIG. 4) and the keyer control icon 406h (FIG. 4). Time sheet views of the present invention are described next.

### F. Time Sheet Views

As described above with reference to FIG. 4, the time sheet includes a horizontal timeline 402 and one or more horizontal control lines 404a-404p. Automation control icons 406a-406t are positioned onto control lines 404a-404p at various locations relative to timeline 402, and configured to be associated with one or more video production commands and at least one video production device. The time sheet of GUI 133 provides user selectable and definable views of the time sheet (e.g., user layouts). The present invention provides at least two different view property types, including grouping views and visible rows.

1. Time Sheet Window

The user can resize the time sheet window to see more rows. In an embodiment of the present invention, three rows in the time sheet are fixed. A GPI-Slug row is fixed at the top of the time sheet window. The layer handles are fixed at the bottom of the time sheet window. (See, for example, FIG. 12 and example TME layer GUI that illustrates two handles, handle 1202 and handle 1204, located at the bottom of the time sheet window.) The TME label row is typically fixed above the group handle row. This example embodiment of fixed rows is not meant to limit the invention.

In an embodiment of the present invention, time sheet rows typically have a height of 32 pixels. Typically, sixteen (16) rows can be seen in the default window size of the time sheet. If there are more visible rows than can be seen in the time sheet window, then the time sheet window can be scrolled from top to bottom with a scroll bar. All rows in the time sheet scroll except for the fixed rows. This example embodiment of the present invention is not meant to limit the invention. As would be apparent to one skilled in the relevant art(s), other time sheet views other than those listed could be provided.

2. Visible Rows of the Time Sheet

In the time sheet setup feature of the present invention described above with reference to FIG. 17, the number and position of rows can be assigned. Each assigned row can be visible or hidden from view. Here, the visible rows are assigned in time sheet setup and stored with the user layout. The present invention allows the user at any time to see all rows in the time sheet. The user can right mouse click anywhere on the time sheet to see the popup menu. Depending on the current view, either “Show Hidden Rows” or “Hide Rows” will be available for selection. If rows are hidden and the user selects “Show All Rows,” all rows are painted to the time sheet in GUI 133. If all rows are visible in the time sheet and rows are selected by the user to be hidden in time sheet setup, and the user selects “Hide Rows,” then only viewable rows are painted to the time sheet of GUI 133.

3. Layering Views of the Time Sheet

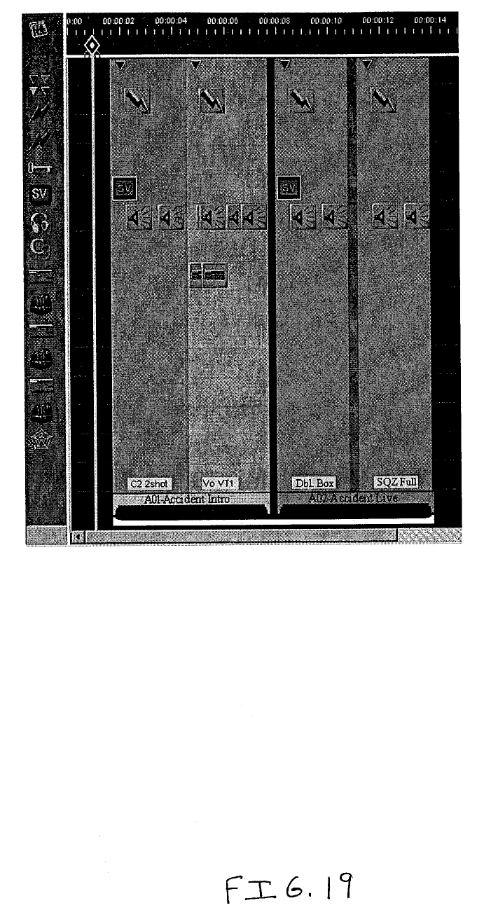

The time sheet of the present invention provides user-selectable layering views. The different views of the time sheet are based on the layer levels described above with reference to FIGS. 10-14. FIG. 10 illustrates that one or more objects make up a TME, one or more TMEs make up a page, one or more pages make up a story and one or more stories make up a show. The present invention provides for group level GUIs that illustrate each of these group layers in the time sheet of GUI 133. The group layer GUIs are illustrated in FIGS. 11-14. Object group layer GUI is illustrated in FIG. 11. TME group layer GUI is illustrated in FIG. 12. Page group layer GUI is illustrated in FIG. 13. Story group layer GUI is illustrated in FIG. 14. FIG. 19 illustrates another embodiment of the page group layer GUI.

The objects or icons are always visible on the time sheet, but the colored grouping levels seen on the time sheet will change with each view (TME, page or story). For example, the TME view will show the TME layer, the page view will show the page layer, and the story view will show the story layer. Operation of the time sheet is described next.

### G. Time Sheet Operation

1. Time Sheet Objects or Icons

Various automation control icons 406a-406t were described above with reference to FIG. 4. These icons included label icon 406a, step mark icon 406b, general purpose input/output (GPI/O) mark icon 406c, user mark icon 406d, encode mark 406e, transition icons 406f-406g, keyer control icon 406h, audio icon 406i, teleprompter icon 406j, character generator (CG) icon 406k, camera icons 406l-406n, VTR icons 406p-406r, GPO icon 406s and encode object icon 406t. Additional embodiments of some of these icons will be described next, along with new icons not described with reference to FIG. 4.

a. GPI/O Mark Icon

GPI/O (general purpose input/output) mark icon 406c is associated with time sheet step commands. The time sheet step commands instruct timer indicator 408 to start or stop running until deactivated or reactivated by the director or another video production device. The default GPI number is one. A GPI/O mark icon property page includes a time control with the GPI/O mark timeline position number. The timeline position number is in time. The time is typically in hours/minutes/seconds/frames (hh/mm/ss/ff). The GPI/O mark icon property page also includes a combo box to select the triggering GPI/O number. When a GPI signal for the assigned GPI is received, timer indicator 408 begins to play.

b. Jump Mark Icon

The jump mark icon (not shown in FIG. 4) is similar to step mark icon 406b. When timer indicator 408 hits a jump mark icon it jumps to the next GPI mark icon on the timeline. All icons to the right of the jump mark icon and up to the left GPI mark icon are executed. If a jump mark icon triggers another jump mark icon, the jumps do not accumulate. No matter how many jump mark icons timer indicator 408 encounters, it will only jump to the next GPI mark icon. If no GPI mark icon is on the timeline to the right of the jump mark icon, then timer indicator 408 does not jump. A GPI mark property page includes a time control with the jump mark timeline position number. The timeline position number is in time. The time is in hours/minutes/seconds/frames (hh/mm/ss/ff).

c. DVE Mark Icon

A DVE (digital video effects device) mark icon has three triggers that include a prep (pre-process), a trans (process) and a post (post-process). Prep (pre-process) occurs (a user definable number of frames) to the left of the left edge of the DVE mark icon. Trans (process) occurs at the left edge of the DVE mark icon.

The user definable prep number can be a global prep number or individually assigned number for each time sheet icon type. Typically, the minimum number is two (2) frames. The typical default prep number is ten (10) frames.

DVE mark icon pre-process only occurs if the previous DVE mark icon, for the same DVE, has completed its duration. The prep commands are buffered. When the previous DVE mark icon completes its transition, the prep commands are sent.

The items that are prepped may include: DVE process effects for the assigned DVE button; video switches for the assigned fields (program, preview, aux1, aux2, preview keyers fill, preview keyers hole); and preview keyers turn (on or off) at prep. The DVE trans occurs at the left edge of the DVE mark icon. The DVE trans can only occur after prep is completed. A left mouse double click on the DVE mark icon opens the DVE property page.

d. Keyer Icon

Keyer icons have three triggers, prep (pre-process) and trans (process) and (post process). Prep occurs a user definable number of frames to the left of the left edge of the keyer icon. Trans occurs at the left edge of the keyer icon. The items that at prep include video switches for the assigned fields (aux keyers background, aux keyers fill, aux keyers hole, DSK keyers fill, DSK keyers hole). The items that occur at trans include: aux keyers turn (on or off) at trans; DSK keyers turn (on or off) at trans and video switches to the aux video outs occur at trans.

e. Audio Icon

As described above with reference to FIG. 4, audio icon 406i can be positioned onto control line 404e and is associated with commands for controlling audio equipment, such as audio mixers, digital audio tape (DAT), cassette equipment, other audio sources (e.g., CDs and DATs), and the like. Audio icons trigger on the left edge of the audio icon. A left mouse double click on the audio icon opens the audio property page.

f. Script Viewer Icon

Script viewer icons trigger on the left edge of the script viewer icon. A left mouse double click on the script viewer icon opens the script viewer property page.

g. CG/SS Icon

CG/SS icons trigger on the left edge of the CG/SS icon. A left mouse double click on the CG/SS icon opens the CG/SS property page.

h. Machine Control Icon

Machine control icons trigger on the left edge of the machine control icon. A left mouse double click on the machine control icon opens the machine control property page.

i. Camera Preset Icon

Camera preset icons trigger on the left edge of the camera preset icon. A left mouse double click on the camera preset icon opens the camera preset property page.

j . GPO Icon

As described above with reference to FIG. 4, GPO icon 406 is associated with commands for controlling GPI or GPO devices. GPO icons trigger on the left edge of the GPO icon. A left mouse double click on the GPO icon opens the GPO property page.

2. Timer Indicator Controls

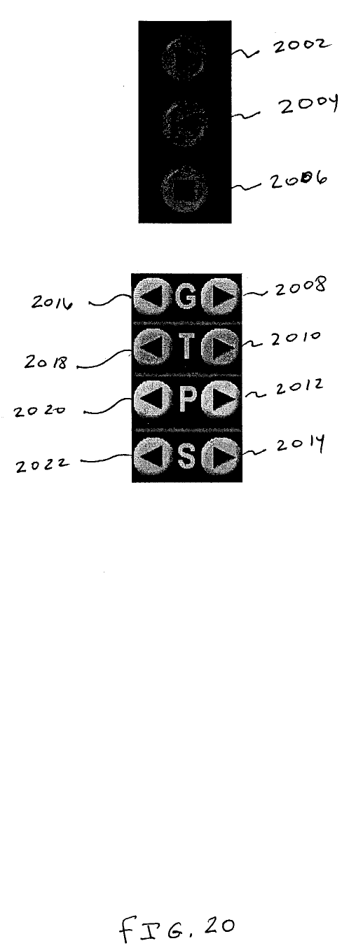

As described above with reference to FIG. 4, a timer (not shown) is integrated into timeline 402, and operable to activate a specific automation control icon 406a-406t as a timer indicator or cursor 408 travels across timeline 402 to reach a location linked to the specific automation control icon 406. The timer indicator maybe controlled via GUI controls, keyboard controls, GPI inputs and an optional shot box. Cursor controls include play, cue, stop, next/previous GPI, next/previous TME, next page, and next story. Each of these are described next with example GUI buttons in FIG. 20. It is important to note that the example GUI buttons in FIG. 20 are for illustration purposes only and are not meant to limit the invention.

a. Play

Timer indicator 408 starts when a GUI Play Button 2002 is pressed. Timer indicator 408 may also start when the (Alt and Spacebar keys) on the keyboard are pressed. When timer indicator 408 stops at a GPI mark, timer indicator 408 starts when it receives a GPI input. Timer indicator 408 also starts when a ShotBox Play Button is pressed.

b. Cue

Timer indicator 408jumps back to the beginning of timeline 402 when the Alt key on the keyboard and a GUI Cue Button 2004 are pressed. Timer indicator 408 jumps back to the beginning of timeline 402 when the Alt C keys on the Keyboard are pressed. When timer indicator 408 is cued, it automatically stops before jumping back to the beginning of timeline 402.

c. Stop

Timer indicator 408 stops when a GUI Stop Button 2006 is pressed. Timer indicator 408 stops when the Alt S key on the Keyboard is pressed. Timer indicator 408 stops at GPI marks.

d. Next/Previous GPI

Timer indicator 408 only skips to the next GPI mark when timer indicator 408 is stopped. When a Next G Button 2008 is pressed, timer indicator 408 jumps to the next GPI mark on timeline 402. None of the timeline icons jumped over are executed. When the Previous G Button 2016 is pressed, timer indicator 408 jumps to the previous GPI mark on timeline 402. None of the timeline icons (or objects)jumped over are executed. The ShotBox will have Next and Previous Buttons to advance timer indicator 408 to the next or previous GPI mark.

e. Next/Previous TME

Timer indicator 408 only skips to the next TME when timer indicator 408 is stopped. When a Next T Button 2010 is pressed, timer indicator 408 jumps to the left edged of the next TME on timeline 402. None of the timeline icons jumped over are executed. When a Previous T Button 2018 is pressed, timer indicator 408 jumps to the left edge of the previous TME on timeline 402. None of the timeline icons jumped over are executed. The ShotBox will have Next and Previous Buttons to advance timer indicator 408 to the next or previous TME.

f. Next/Previous Page

Timer indicator 408 only skips to the next page when timer indicator 408 is stopped. When a Next P Button 2012 is pressed, timer indicator 408 jumps to the left edged of the next page on timeline 402. None of the timeline icons jumped over are executed. When a Previous P Button 2020 is pressed, timer indicator 408 jumps to the left edge of the previous page on timeline 402. None of the timeline icons jumped over are executed. The ShotBox will have Next and Previous Buttons to advance timer indicator 408 to the next or previous page.

g. Next/Previous Story

Timer indicator 408 only skips to the next story when timer indicator 408 is stopped. When a Next S Button 2014 is pressed, timer indicator 408 jumps to the left edged of the next story on timeline 402. None of the timeline icons jumped over are executed. When a Previous S Button 2022 is pressed, timer indicator 408 jumps to the left edge of the previous story on timeline 402. None of the timeline icons jumped over are executed. The ShotBox will have Next and Previous Buttons to advance timer indicator 408 to the next or previous story.

3. Timeline Speed

The timeline speed is adjustable by the user within a range. The timeline speed can be adjusted only when timer indicator 408 is stopped. The spacing relationship between timeline icons has a direct relationship to timer indicator 408 speed. When the timeline speed is adjusted, the spacing of timeline icons must be adjusted as well. The timeline speed dialog can be accessed from the timeline setup dialog.

### H. Dynamic Time Sheet

The dynamic time sheet feature of the present invention increases the amount of information with regard to the relationship between icons or group levels on the time sheet. Features of the present invention that relate to the dynamic time sheet include, but are not limited to, dynamic links, intelligent transition macro elements (ITME), TME replacement, auto-channel, global macro changes, and conflict identification. Each of these features are described next with reference to a Newsroom Computer System (NCS). As described above, newsroom management software creates show rundowns. This rundown becomes the running order of stories and events within a show. A rundown converter is the intelligent intermediary between a NCS and video production system 100 (FIG. 1). The NCS is utilized for illustration purposes only and is not meant to limit the invention.

1. Dynamic Links

In an embodiment of the present invention, a dynamic link is maintained with the NCS rundown. As changes are made on the NCS rundown, the time sheet of the present invention is updated with the changes. The rundown converter module will maintain the link between the NCS rundown and the time sheet. The first rundown convert occurs when the user checks a show in the rundown converter dialog. A dynamic link is maintained between the rundown converter module, the NCS and the time sheet until the rundown is unchecked.

The dynamic time sheet has three modes of operation, including an automatic time sheet update mode, a manual time sheet update mode, and a no time sheet update mode. Each of these modes are discussed next.

The rundown converter module may be set to update the time sheet automatically. Here, when a change is made on the NCS rundown, rundown converter automatically updates the time sheet. Alternatively, the rundown converter module may be set to update the time sheet manually. Here, when a change is made on the NCS rundown, rundown converter alerts the time sheet that a change has been made, but the time sheet is not updated until the user accepts the changes. Finally, in the no time sheet update mode, no changes or alerts are sent to the time sheet.

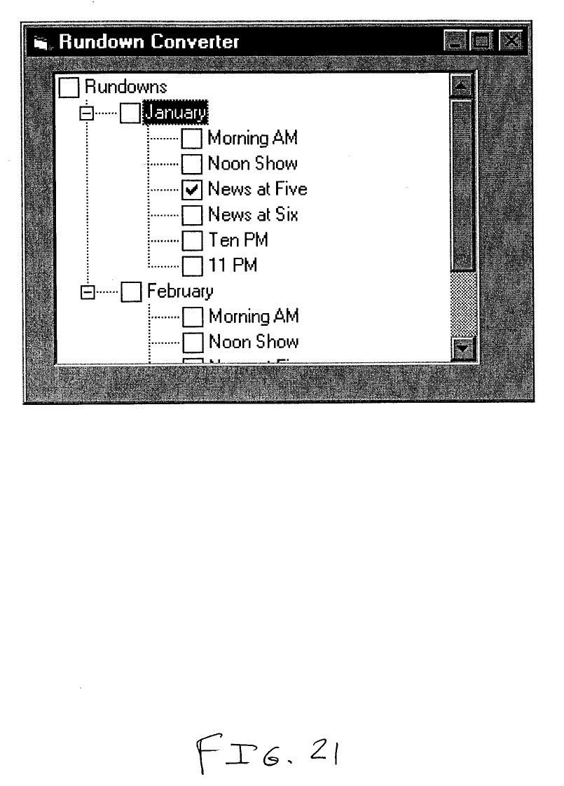

The present invention provides a rundown converter dialog that consists of a tree view and a setup menu. An example rundown converter dialog is shown in FIG. 21. The rundown server setup dialog is used to build the list of available rundowns in the NCS.

2. Intelligent Transition Macro Elements (ITME)

As described above, TME (Transition Macro Elements) is a collection of one or more objects or events or icons on the time sheet. ITME are TME's with built in link rules of operation. These relational instructions, in addition to icon mapping, are used by an interface to the time sheet to make the necessary changes to appropriate linked icons. The time sheet of the present invention can use the same set of build rules used by TME builder.

3. TME Replacement

When a TME is saved, a TME GUID is stored with the TME. If the user wishes to replace all TMEs with the same TME GUID, the user may right click on the mouse and select “Replace TME.” A dialog opens to select the TME to replace the existing TME and all TMEs on the time sheet with the same TME GUID.

4. Auto-Channel

The auto-channel feature of the present invention automatically assigns server channels from a pool of server channels. Each time a server load command is encountered, the auto-channel module would find the next available server channel and make the necessary changes within the appropriate icons based on the ITME instructions. Auto-channel can only pool channels from the same device. Multiple channels may be connected to the same media. When setting up the port for a server device, it can be designated as a pooled device. When the time sheet encounters a pooled device load command identified by its GUID, the auto-channel module would assign the next available channel for that device. Each time a channel is assigned, the interface increments to the next channel. When the last channel in the pool of assigned channels is assigned, the interface resets to the first channel. When the channel is assigned, the auto-channel module uses the ITME link instructions to populate the appropriate time sheet icons.

5. Global Macro Changes

Another feature of the dynamic time sheet of the present invention is the ability to make global changes across the time sheet. This involves replacing a non-linked source with another source, wherever encountered on the time sheet. An example of a desire for a global change would occur if “Mic1” goes bad and the user wants to replace all “Mic1” entries with “Mic2.” The change would be occurring within a single type of icon on the time sheet and would involve replacing a linked source with another source, whenever encountered on the time sheet. Using the ITME link data, the time sheet will make the necessary changes to all linked icons.

6. Conflict Identification

As the present invention increases the ability to maneuver around the time sheet, and increases the amount of relational data between icons on the time sheet, there is a need to add intelligence to the time sheet to be able to identify conflicts. The present invention provides a set of global rules that comprise known production or system violations that produce on-air mistakes. For example, if a camera is on-air and the time sheet encounters a camera preset that is different from the last camera preset issued for that camera, then an error message should be given. In another example, if a tape or sever machine is on-air and the time sheet encounters a tape or server cue command, then an error message should be given. A further example is if a CG channel is on-air and the time sheet encounters a CG command for that CG channel, then an error message should be given. These global rules are provided for illustration purposes only and are not meant to limit the invention.

### I. Enhanced Time Sheet Look Ahead (ETLA)

The ETLA (enhanced time sheet look ahead) feature of the time sheet is designed to act on (e.g., select time sheet icons) as soon as those icons are free from their current operation. The farther in advance a device can be prepped or cued, the less time it takes to air the device. The ETLA operation is seamless to the end user, because the operational rules are built into the time sheet.

Some of the benefits of the ETLA feature of the present invention includes icon status for future conflict (identification or resolution); it guarantees no unwanted on-air cueing; it provides for a tighter, faster show pace due to pre-load media; and it provides for a visually clearer time sheet due to better-defined group level separation.

The following definitions are provided for the ETLA feature of the present invention.

ETLA (Enhanced Time sheet Look Ahead)—the process in which the time sheet searches ahead to the right of the timer indicator looking for ETLA icons to trigger.

ETLA Search—the point at which the time sheet begins looking for the next ETLA icon to trigger.

Done—when an icon is no longer on-air or needed for a particular TME or story. There are multiple levels of Done. They include: TME Done—when timer indicator 408 steps past the first GPI Mark in the next TME; Page Done—when timer indicator 408 steps past the first GPI Mark in the next page; and Story Done—when timer indicator 408 steps past the first GPI mark in the next story.

Various ETLA icons include, but are not limited to, a camera preset icon, a still store load icon, a VTR cue icon and a server load icon.

1. ETLA Search

The ETLA Search is done at different levels, with a set of boundaries. The boundaries are determined by which time sheet groups levels (TME, Story) the ETLA icons reside. The first ETLA search begins when timer indicator 408 stops at the first GPI mark on the time sheet.

Each time timer indicator 408 advances past the first GPI mark of a new TME, a search begins. The first occurrence of each ETLA icon (i.e., camera preset, still store load, VTR cue, server load) to the right of timer indicator 408 is searched for on the time sheet. Regarding the TME group level, if an ETLA icon is part of the TME group when the ETLA search begins, then that ETLA icon type is not searched for until timer indicator 408 passes the first GPI mark of the next TME. The ETLA search does not extend beyond the current story. Regarding the page group level, if an ETLA icon is part of the page level when the ETLA search begins, then that ETLA icon type is not searched for until timer indicator 408 passes the first GPI mark of the next page. Regarding the story group level, if an ETLA icon is part of the story level when the ETLA search begins, then that ETLA icon type is not searched for until timer indicator 408 passes the first GPI mark of the next story. Finally, with the show group level, an ETLA search will look for ETLA icons until it reaches the end of the show level.

2. ETLA Rules

The present invention provides ETLA rules. For example, one ETLA rule states that no ETLA icon is triggered (executed) if the icons associated source is on-air. Another rule is that all ETLA icons are triggered (executed) on left edge of the icon, if the (Preset, ID, Timecode, Clip ID) is different from the last loaded (Preset, ID, Timecode, Clip ID) for that device or device channel and the icons associated source is not on-air.

Another ETLA rule provided by the present invention is that the first search begins when timer indicator 408 stops at the first GPI mark on the time sheet. For the TME level, timer indicator 408 passes the first GPI mark of a new TME. For LBN insertion, when the LBN is dropped on the time sheet, the search begins to the right of timer indicator 408. For the time sheet jump, when timer indicator 408 is moved by jumping to the next (TME, Page, Story) or time sheet bar jumping, the search begins to the right of timer indicator 408.

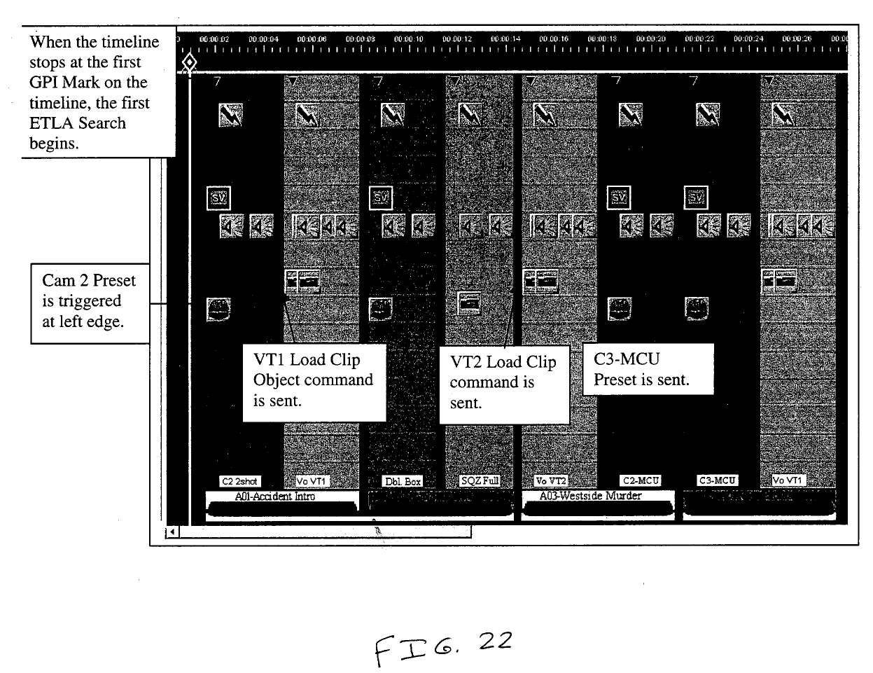

In the example in FIG. 22, when timer indicator 408 stops at the first GPI mark on the time sheet, the ETLA search begins. The first occurrence of each ETLA icon type, to the right of timer indicator 408, is searched for on the time sheet. The boundaries of the search for each ETLA icon is set by the group level of each icon. Since timer indicator 408 rests in the first TME and the camera preset ETLA icon is part of that TME, that icon is not searched for on the rest of the time sheet at this point. The first ETLA icon found to the right of timer indicator 408, not in the current TME, is the “VT1 Load Clip” icon. Since this is the next occurrence of this icon and “VT1” is not on-air, the clip is loaded. The search ends for this icon type. The next ETLA icon found to the right of timer indicator 408 is the camera 3 preset. The camera 3 preset is sent and the search ends for this icon type. The next ETLA icon found to the right of timer indicator 408, is the “VT2 Load Clip” icon. Since this is the next occurrence of this icon and “VT2” is not on-air, the clip is loaded. The search ends for this icon type.

### J. Graphical Time Sheet View

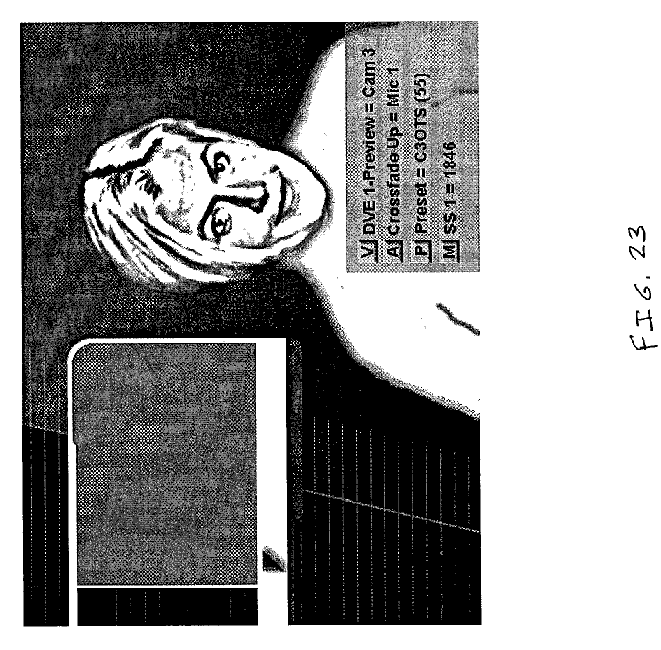

The graphical time sheet view 2300 in FIG. 23 is a different way of representing the events on the time sheet. Instead of rows and icons, the time sheet would consist of a graphical representation of the events output. For example if the event was an OTS (Over the shoulder) TME, then the graphical representation would contain an image to represent the camera shot position and an image to represent the OTS Graphic. Control icons to control the different icons make up an event. For example, a V-button may be used to control the video switching, an A-button may be used to control the audio switching, a P-button may be used to control the camera preset, and a M-button may be used to control the device of the OTS.

### K. Example Environment of the Present Invention

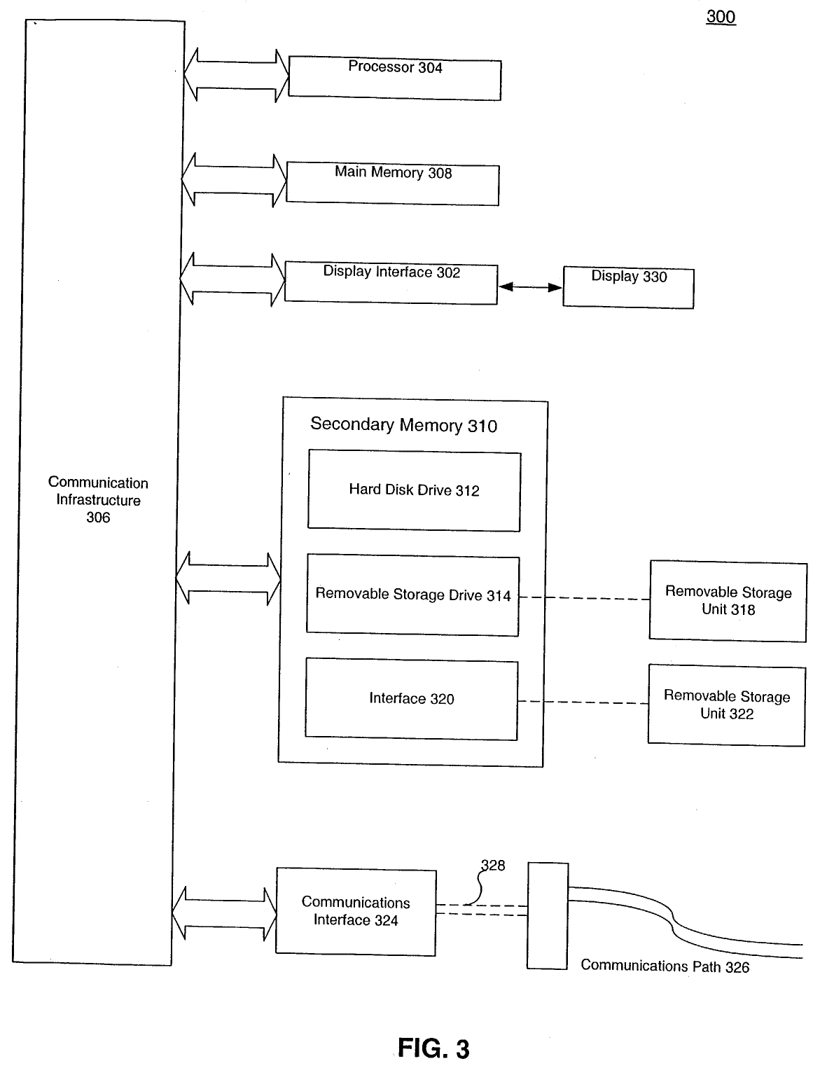

Referring to FIG. 3, an example computer system 300 useful in implementing the present invention is shown. The computer system 300 includes one or more processors, such as processor 304. The processor 304 is connected to a communication infrastructure 306 (e.g., a communications bus, crossover bar, or network). Various software embodiments are described in terms of this exemplary computer system. After reading this description, it will become apparent to a person skilled in the relevant art(s) how to implement the invention using other computer systems and/or computer architectures.

Computer system 300 can include a display interface 302 that forwards graphics, text, and other data from the communication infrastructure 306 (or from a frame buffer not shown) for display on the display unit 330.

Computer system 300 also includes a main memory 308, preferably random access memory (RAM), and can also include a secondary memory 310. The secondary memory 310 can include, for example, a hard disk drive 312 and/or a removable storage drive 314, representing a floppy disk drive, a magnetic tape drive, an optical disk drive, etc. The removable storage drive 314 reads from and/or writes to a removable storage unit 318 in a well-known manner. Removable storage unit 318, represents a floppy disk, magnetic tape, optical disk, etc. which is read by and written to removable storage drive 314. As will be appreciated, the removable storage unit 318 includes a computer usable storage medium having stored therein computer software and/or data.

In alternative embodiments, secondary memory 310 can include other similar means for allowing computer programs or other instructions to be loaded into computer system 300. Such means can include, for example, a removable storage unit 322 and an interface 320. Examples of such can include a program cartridge and cartridge interface (such as that found in video game devices), a removable memory chip (such as an EPROM, or PROM) and associated socket, and other removable storage units 322 and interfaces 320 which allow software and data to be transferred from the removable storage unit 322 to computer system 300.

Computer system 300 can also include a communications interface 324. Communications interface 324 allows software and data to be transferred between computer system 300 and external devices. Examples of communications interface 324 can include a modem, a network interface (such as an Ethernet card), a communications port, a PCMCIA slot and card, etc. Software and data transferred via communications interface 324 are in the form of signals 328 which can be electronic, electromagnetic, optical or other signals capable of being received by communications interface 324. These signals 328 are provided to communications interface 324 via a communications path (i.e., channel) 326. This channel 326 carries signals 328 and can be implemented using wire or cable, fiber optics, a phone line, a cellular phone link, an RF link and other communications channels.

In this document, the terms “computer program medium” and “computer usable medium” are used to generally refer to media such as removable storage drive 314, a hard disk installed in hard disk drive 312, and signals 328. These computer program products are means for providing software to computer system 300. The invention is directed to such computer program products.

Computer programs (also called computer control logic) are stored in main memory 308 and/or secondary memory 310. Computer programs can also be received via communications interface 324. Such computer programs, when executed, enable the computer system 300 to perform the features of the present invention as discussed herein. In particular, the computer programs, when executed, enable the processor 304 to perform the features of the present invention. Accordingly, such computer programs represent controllers of the computer system 300.

In an embodiment where the invention is implemented using software, the software can be stored in a computer program product and loaded into computer system 300 using removable storage drive 314, hard drive 312 or communications interface 324. The control logic (software), when executed by the processor 304, causes the processor 304 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### L. Conclusion

While various embodiments of the present invention have been described above, it should be understood that they have been presented by way of example, and not limitation. It will be apparent to persons skilled in the relevant art that various changes in form and detail may be made therein without departing from the spirit and scope of the invention. This is especially true in light of technology and terms within the relevant art(s) that may be later developed. Thus, the present invention should not be limited by any of the above-described exemplary embodiments, but should be defined only in accordance with the following claims and their equivalents.

What is claimed is:

1. A method for controlling a production studio for producing a television show, the method comprising:
sending control commands to a plurality of video production devices from a processing unit;
associating one or more icons representing video production device control buttons with one or more control commands;
creating, via a hierarchical user interface, a transition macro by placing one or more of said icons on a time sheet; and
executing, via said hierarchical user interface, said transition macro to control said plurality of video production devices during the television show.

2. The method of claim 1, wherein the creating step includes placing one or more of said icons on said time sheet to create a hierarchical view of group layers.

3. The method of claim 2, wherein said hierarchical view of group layers is a graphical user interface view.

4. The method of claim 2, wherein said hierarchical view of group layers include one or more of an object group layer, a TME group layer, a page group layer, a story group layer and a show group layer.

5. The method of claim 4, wherein said TME group layer, said page group level and said story group layer each have an associated handle that provides for the maneuverability of the layer.

6. The method of claim 4, wherein said object group layer may be a member of said TME group layer, said TME group layer may be a member of said page group layer, said page group layer may be a member of said story group layer and said story group layer may be a member of said show group layer.

7. The method of claim 1, further comprising maintaining a dynamic link between a newsroom computer system and said time sheet.

8. The method of claim 1, wherein two or more of said icons, each being associated with different ones of said video production devices, are placed on said time sheet so that they are executed simultaneously during said executing step.

9. The method of claim 8, further selecting one or more of said icons to execute as soon as they are free from their current operation.

10. The method of claim 1, wherein said plurality of video production devices includes one of a camera, a character generator, a digital video effect (DVE) device, and an audio mixer.

11. The method of claim 1, where said icon is one of GPI/O Mark Icon, Jump Mark Icon, DVE Mark Icon, Keyer Icon, Audio Icon, Script Viewer Icon, CG/SS Icon, Machine Control Icon, Camera Preset Icon, and GPO Icon.

12. A system for controlling a production studio for producing a television show, comprising:
a processing unit that sends control commands to a plurality of video production devices;
one or more icons that represent video production device control buttons associated with one or more control commands; and
a hierarchical user interface that is used to create a transition macro by placing one or more of said icons on a time sheet, wherein said hierarchical user interface is also used to execute said transition macro to control said plurality of video production devices during the television show.

13. The system of claim 12, wherein one or more of said icons are placed on said time sheet to create a hierarchical view of group layers.

14. The system of claim 13, wherein said hierarchical view of group layers is a graphical user interface view.

15. The system of claim 13, wherein said hierarchical view of group layers include one or more of an object group layer, a TME group layer, a page group layer, a story group layer and a show group layer.

16. The system of claim 15, wherein said TME group layer, said page group level and said story group layer each have an associated handle that provides for the maneuverability of the layer.

17. The system of claim 15, wherein said object group layer maybe a member of said TME group layer, said TME group layer may be a member of said page group layer, said page group layer may be a member of said story group layer and said story group layer may be a member of said show group layer.

18. The system of claim 12, further comprising a dynamic link between a newsroom computer system and said time sheet.

19. The system of claim 12, wherein two or more of said icons, each being associated with different ones of said video production devices, are placed on said time sheet so that they are executed simultaneously during said executing step.

20. The system of claim 19, wherein one or more of said icons are selectd to execute as soon as they are free from their current operation.

21. The system of claim 12, wherein said plurality of video production devices includes one of a camera, a character generator, a digital video effect (DVE) device, and an audio mixer.

22. The system of claim 12, where said icon is one of GPI/O Mark Icon, Jump Mark Icon, DVE Mark Icon, Keyer Icon, Audio Icon, Script Viewer Icon, CG/SS Icon, Machine Control Icon, Camera Preset Icon, and GPO Icon.
